(19) United States
(12) Patent Application Publication
(10) Pub. No.: US 2017/0364836 A1
(43) Pub. Date: Dec. 21, 2017

(54) SYSTEM AND METHOD FOR MANAGING RESERVATIONS

(71) Applicant: Elias Li, Overland Park, KS (US)

(72) Inventor: Elias Li, Overland Park, KS (US)

(73) Assignee: Elias Li, Overland Park, KS (US)

(21) Appl. No.: 15/626,149

(22) Filed: Jun. 18, 2017

Related U.S. Application Data
(60) Provisional application No. 62/351,951, filed on Jun. 18, 2016.

(51) Int. Cl. G06Q 10/02; G06Q 20/10; G06Q 30/02; G06Q 50/12

(52) U.S. Cl. CPC G06Q 10/02; G06Q 50/12; G06Q 20/102; G06Q 30/0201

(57) ABSTRACT

The present disclosure is directed to systems and methods for managing reservations. A computer-implemented method for use with a system for managing reservations includes: transmitting, via a vendor transmission apparatus of a vendor device, availability data for a vendor to a display apparatus of a user device, the display apparatus configured to display information on the user device; receiving, via a user transmission apparatus of the user device, reservation request data for the vendor; determining, via a reservation data server coupled to the vendor device and the user device, if there is an available seat at the vendor having the vendor device; charging, via the reservation data server, the user device a variable fee amount in order to reserve the available seat, the variable fee amount being able to be modified by the vendor device; and delivering, via the vendor transmission apparatus, confirmation to the display apparatus of the user device that the available seat has been reserved.

### CROSS REFERENCE TO RELATED APPLICATIONS

This application claims the benefit of U.S. Provisional Application Ser. No. 62/351,951, “System and Method for Managing Reservations” filed on Jun. 18, 2016, the entirety of which is herein incorporated by reference.

### TECHNICAL FIELD

The present disclosure generally relates to systems and methods for facilitating reservation making or organizing events during specific dates and times in the service industry context, particularly to systems and methods for managing reservations.

### BACKGROUND

Currently, software applications exist that can be used on a mobile smartphone or pad device, for example, to make reservations at restaurants or other stores. However, such software applications are problematic, primarily because many restaurants, vendors or stores do not use them—only users do—and they are also inefficient, do not correctly manage inventory and prices, and contain outdated booking information that is also inaccurate and needs to be constantly refreshed. Furthermore, many vendors may not have an incentive to make seats at their restaurants available due to inadequate compensation, or too large a share being taken via other applications. Therefore, there is currently no software application or wider system or method not limited to devices that allows the convenient and accurate management of reservations at various stores, vendors, restaurants and other similar locations, and where vendors may receive adequate compensation so as to motivate them to use such a .reservation application.

### SUMMARY

Provided is a computer-implemented method for use with a system for managing reservations, including: transmitting, via a vendor transmission apparatus of a vendor device, availability data for a vendor to a display apparatus of a user device, the display apparatus configured to display information on the user device; receiving, via a user transmission apparatus of the user device, reservation request data for the vendor; determining, via a reservation data server coupled to the vendor device and the user device, if there is an available seat at the vendor having the vendor device; charging, via the reservation data server, the user device a variable fee amount in order to reserve the available seat, the variable fee amount being able to be modified by the vendor device; and delivering, via the vendor transmission apparatus, confirmation to the display apparatus of the user device that the available seat has been reserved.

Provided also is a computer-implemented system for managing reservations, including: at least one computing device configured to submit reservation request data and confirmed availability request data to a reservation data server and to receive vendor availability data and confirmed reservation data from the reservation data server, the at least one computing device comprising a graphic user interface (GUI) and a plurality of user input keys and the reservation request data, the vendor availability data, the confirmed availability request data and the confirmed reservation data are associated with at least one vendor; a reservation data server to receive, store and process reservation request data, receive availability data from the at least one vendor and confirmed availability data and output confirmed reservation data, the reservation data server comprising: a vendor availability processor configured to receive and transform the reservation request data and the availability data from the at least one vendor into vendor availability data and transmit the vendor availability data to the at least one computing device; and a reservation processor configured to receive and transform the confirmed availability request data into confirmed reservation data; and the at least one vendor, each configured to transmit availability data to the reservation data server for a nominal fee.

Provided is also a computer-implemented system .for managing reservations, including: a vendor device including: a vendor display apparatus configured to display on the vendor device information; and a vendor transmission apparatus configured to transmit availability data for a vendor and also an availability confirmation; a user device including: a user display apparatus configured to display on the user device information including the availability confirmation; and a user transmission apparatus configured to receive reservation request data for the vendor; and a reservation data server coupled to the vendor device and the user device configured to determine if there is an available seat at the vendor using the vendor device, wherein the reservation data server is also configured to charge the user device a variable fee amount in order to reserve the available seat, the variable fee amount being modifiable by the vendor device.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 shows a diagram of various components used for a system to manage reservations, according to an aspect of the present disclosure.

FIGS. 2A-2G show screenshots of an user application used by a system to manage reservations, according to an aspect of the present disclosure.

FIGS. 3A-3B show other screenshots, after certain icons are pressed, of an user application used by a system to manage reservations, according to an aspect of the present disclosure.

FIGS. 4A-4D show yet other screenshots, after certain icons are pressed, of an user application used by a system to manage reservations, according to an aspect of the present disclosure.

FIGS. 5A-5B show homepage screenshots of a host application used by a system to manage reservations, according to an aspect of the present disclosure.

FIG. 6 shows a screenshot, after certain icons are pressed from the homepage, of a host application used by a system to manage reservations, according to an aspect of the present disclosure.

FIG. 7 shows another screenshot, after certain icons are pressed from the homepage, of a host application used by a system to manage reservations, according to an aspect of the present disclosure.

FIGS. 8A-8E show other screenshots, after certain icons are pressed from the homepage, of a host application used by a system to manage reservations, according to an aspect of the present disclosure.

FIGS. 9A-9C show yet other screenshots, after certain icons are pressed from the homepage, of a host application used by a system to manage reservations, according to an aspect of the present disclosure.

FIGS. 10A-10B show screenshots, after certain icons are pressed from the screenshots shown in FIGS. 9A-9C of a host application used by a system to manage reservations, according to an aspect of the present disclosure.

FIG. 11 shows a process flowchart of a method to manage reservations, according to an aspect of the present disclosure.

FIG. 12 shows a diagram of a system for managing reservations, according to an aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art; however, that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

According to one aspect of the disclosure, a user or customer (“user”) has a software application on a mobile smartphone or pad device (“app”) that will show him or her from a universe of locations where he or she can purchase or rent (“buy”) food or any other service from any vendor, restaurant, store (“host”) based on his or her location. The user may also set-up a main account and different auxiliary accounts based on different profiles of a user. For example, there may be business and personal accounts for the same user. For each account, credit card information is captured and stored. Therefore, separate credit card information for a business profile (say, entertaining clients on a business account) versus a personal profile (personal meals) can be used.

According to one aspect of the present disclosure, a user can “buy” a seat at an available restaurant. Only restaurants that have an available inventory of open seats will come up on the user's app. The user will pay with whatever card is on file for that account, which then charges the user a “fee” to use the system for managing reservations (“the system”). The fee may be based on the price of a seat at that restaurant plus a variable 5 or 10% markup based on type of restaurant. The user can also “buy” food for “pickup”. Some restaurants will have online ordering available—mostly quick and fast service restaurants, but fine dining establishments as well. If a fine dining restaurant wants to provide pickup service, the system can process such requests as well. Also, this pickup and delivery service extends to hosts such as stadiums, concerts and any other venues who do concessions—where the concessions can be delivered to venue attendees, or can be picked up by attendees as well.

According to one aspect of the disclosure, when the user wishes to reserve a seat at a restaurant, the app will confirm the user's purchase for “eat in.” The app may then send to the user who bought a reserved seat at the restaurant an identification (“ID”) which may include a “QR” code with a unique identification number or string or code or combination thereof, or just a unique identification number or string or code or combination thereof, without a QR code. The user will need the ID in order to “check in” (for eating in) or “pick up” (for delivery) at the restaurant.

In one aspect of the disclosure, after the user gets their ordered meal delivered, or eats at the restaurants, he or she can also “rate” their experience. You can only rate locations or hosts after you have actually dined there or ordered from there.

In one aspect of the disclosure, restaurants will have a different app with a dashboard, or have a dashboard that shows up differently than the standard dashboard. In one aspect of the disclosure, there is a guest app and a host app. The host app will have a host dashboard that is completely different from the guest dashboard of the guest app. In one aspect of the disclosure, the host dashboard and the guest dashboard may be similar or the same.

In one aspect of the disclosure, vendors, stores and restaurants (“hosts”) will have to create accounts in order to be listed as hosts/restaurants viewable on the consumer side, usually via a graphic user interface on the app. In one aspect of the disclosure, hosts will put in all information regarding their restaurant—including the “price” per seat and date and time of the “seats.” The hosts may also need to create an account with a Merchant associated with the users to accept payment, such as PayPal, Venmo, Chase QuickPay, and so on. Whenever a user buys a “seat” or “buys” food, the user is charged and the amount is effectively “split” between the company that runs the system for managing reservations and the restaurant. The company running the system for managing reservations may also take on any incurred “credit card fees” and simply give a total amount to the restaurant.

In one aspect of the disclosure, when a user comes to the restaurant, the user will show the restaurant the ID. The restaurant or host can then simply click “CHECK IN”. For a pick up order, the host or restaurant may just match the orders and give the user the food that the users have ordered.

In one aspect of the disclosure, the app will have a full reservation dashboard showing the front of the house for a given restaurant or host. Users will be able to do waitlist requests, and walk-ins, while other people without the systems have to deal with phone or open table reservations.

In one aspect of the disclosure, a system where a user can pull up a separate SUB account per each restaurant so each and every waiter or member of the wait staff can log into this SUB account and take orders tableside. Once the orders are placed, the diner can then see the entire bill and just pay through their smartphone or mobile device.

In one aspect of the disclosure, the system links Point of Sale (POS) to many different hosts. Each POS will have a different API that will link the system's platform integrating it with any and/or all POS systems out there. Some restaurants or hosts will want to be linked, some will come through directly through the app. Users can sign onto any platform without an integration to the POS system. However, if a user is using the system's platform through a POS system, they will still need to download the system's application to sign onto the system. The way in which the system links to the POS systems is unique and distinguishable from other software applications.

In one aspect of the disclosure, if a user comes to a host directly through the app, the host can get the entire credit card fee (charged to the user) paid for. In one aspect of the disclosure, if a user conies through a POS system that was referred to the system, the referring POS company or referring company will get a revenue share of the credit card fee. For example, a 3% credit card fee. As an illustration, if a POS called CLOVER, which is a point of sale system or host owned by First Data, sent the restaurant to the system to sign up, the system pays CLOVER a 1.5% referral fee on each transaction and the restaurant gets 1.5% of the credit card fee paid for. In one aspect of the disclosure, the POS host is primarily app-driven. The system will also be able to integrate with a number of different currently existing POS hosts. In one aspect of the disclosure, the system engages in a profit-share mechanism with those POS hosts once the POS hosts integrate with the system. If users come through the app through a phone conversation with the sales team of the company that runs the restaurant, the restaurant will get the whole 3% fee paid for by the system.

Dynamic Pricing and Calibration of Reservations

One major advantage is that the variable fee or fee that a user has to pay in order to reserve a seat or ticket at a vendor or host is dynamically calibrated based on a number of different factors including current time demand, historical time transaction data and local geographical data. The current time demand reflects the demand of reservations at the vendor or host at the current time. The historical time transaction data describes the history of transactions users may have with the vendor or host. The local geographical data describes the geographic location where the vendor is located. These factors work together to adjust and calibrate a dynamic, variable fee price for the reservations that benefits users and vendors alike.

Prepayment and Not Just Mere Reservations

The reservation made at a vendor or host is not a mere reservation and is a pre-payment, meaning that the reservation is paid for even before the user comes in and sits down at the restaurant. Therefore, this is a distinction between other prior art restaurant reservation apps out there in that those apps deal with reservations, many of which have often not been paid, while the current application of the present system deals with pre-payments of reservations, which have already been paid, by a user.

Promotions Controlled by Vendors and Based on In-Time Demand

Also, the present system allows promotions, events (such as “meet the chef”), incentives, deals, discounts to be modified based on current demand, and in real time. For example, say a restaurant declares a special deal that if a user books two or more seats at $25 a seat, the user can get a free dessert. Only available Monday through Thursday. This allows vendors such as restaurants and businesses to offer special time sensitive offers, in real time and as needed. If the vendors want to pull or remove the offers, they can do that when they want, and it's only good for the days the vendor says it is good for.

QR Codes Can Be Used for Ticketing

Because a QR Code and unique ID is generated after each seat or reservation is purchased, such an identification code can be used as a ticketing mechanism. These identification codes include a QR code, barcode, a passcode, a confirmation number, a confirmation word, a confirmation image and any other image or code identifying that the user purchased a ticket. For example, a vendor can place an event on the app. If a user clicks on that event, a seat can be purchased for that date and time. The user can then be given a QR code and unique ID that can then be used for entry into the event.

Furthermore, prices for that event will change based on the time the user wants to come in. As a further example, if a user wants to come to a EXPO at 10 am—it's $15, but if you come in at 3 pm it's only $10 because there is only 2 hours left for the event.

Variety of Restaurants

In one aspect of the disclosure, the system and app will include not just full service restaurants (FSR), but also all types of restaurants such as quick service restaurants (QSR) and fast casual restaurants (FCR). This is a feature distinguishable from other software applications or reservation systems currently being used. The disclosed system therefore is not just a reservation system because the food is actually being purchased as point of sale (POS) on the smartphone, cellphone or mobile device.

To describe the above feature in further detail, a user will be able to order for pick up from any and all restaurants, including—Chinese food, Mexican food, burgers, drinks, smoothies. Basically food from any type of host that is willing to have the food item ready as the customer pulls up for either eating in, or take out. This would include any and all buffet lines as well, and would be ideal for all the casinos in Las Vegas.

In one aspect of the present disclosure, the system and app could also include a delivery feature. Another service or system that specializes in delivery (e.g., transportation applications such as Uber or GrubHub, DoorDash, etc.).

Profile System of App

In one aspect of the disclosure, the app will have a “profile system” where a customer can have multiple profiles. For example, as discussed previously, Business and personal. Therefore, different credit cards would be in place for each profile. Also, the platform can remember any of your QSR and Fast food orders, so you can order them with one click or swipe. As an example, a user always orders 2 double cheese burgers, 1 set of fries and 1 drink at a Hamburger Restaurant, and that order would be remembered. So, you would be able to take that order anywhere else, and send to which ever location you were closest to: either another branch of that Hamburger Restaurant, or another similar restaurant that is entirely different. This can happen with any and all restaurants which allow for take-out or delivery orders.

Advantageous Seating/Serving

In one aspect of the disclosure, the system just doesn't take reservations, but actually seats customers by taking them to their reserved seats or open seats, and sells food to these customers with the convenience fee already applied. Therefore, food transactions are handled in a more efficient manner, and the process for dining out is streamlined and made more convenient for the diner or customer. In one aspect of the disclosure, restaurants or hosts can price their seats different prices for different nights, say if there was a promotion for a particular day of the week, say Taco Tuesday.

Meet The Chef Feature

When the host/restaurant is experiencing a slow day, users/customers will be able to engage in a “meet the chef” feature, which allows the users/customers to meet the chef and talk to them in person or via video-conference or another online tool. This can drive interactions on social media to the host/restaurant and drive more users/customers or diners to the host/restaurant on slow days, such as Monday through Thursday. Other events similar to a meet the chef event include any promotion, any discount, any purchasing deal, any purchasing incentive, a meet the founder event, a fundraising event, a birthday party, a wedding, a bachelor's party, a religious party event, a business presentation, a business meeting, an internal company event and a networking event, for example.

Food Truck Market or Pop-Up Restaurants

According to an aspect of the disclosure, the system is compatible and works well with the food truck industry because the system is location-based and can change user selections of hosts/restaurants in real-time. Food trucks, pop-up restaurants, hosts or cans at sporting events, and similar establishments are also compatible with this feature of the system.

Pass Through Business Model

According to an aspect of the disclosure, the system is able to exercise a pass-through business model where the expenses are not incurred at all by the hosts/restaurants. Instead, the users/customers pay for everything, and their motivation to purchase a seat at a popular restaurant will drive the demand for the system to be used. Furthermore, because the host/restaurant is not charged, all hosts/restaurants will be encouraged to use the system. Prices will also be flexible. The user/customer will be the only party charged, because they are paying for a service unavailable anywhere else. Restaurants/hosts will also be able to offer promotions and deals in order to encourage users/customers to attend their establishments.

Line-less Reservation System

According to an aspect of the disclosure, users/customers do not have to wait in a line because they will specify a specific appointment time and date, and therefore, will be seated at that exact time and date by the host/restaurant. Therefore, a line is avoided and customers purchasing reservations will be led directly to their tables when it is their appointment time, without any waiting.

Geographic Search and Still Open Feature

According to an aspect of the disclosure, users/customers will be able to use the system on a mobile phone or smart tablet to search, via a GPS system, for restaurants that are near them and that (i) use the system and/or (ii) are still open for business or open for dine-in or delivery. This feature will use a GPS technology similar to ridesharing mobile applications to locate the user/customer and also locate any nearby hosts/restaurants that utilize the system. Then, information about nearby hosts/restaurants, including if they are still open, will be presented to the user/customer in order for the user/customer to place orders. Furthermore, the user/customer will be able to choose to see only those restaurants/hosts that are still open near them, in order to make their selections. In one implementation, the user/customer can set a certain distance (e.g., X mile radius) to observe which restaurants/hosts are near them, which will save processing resources for nearby establishments. The open hours information can be acquired by web-crawling other sites or attained through other publicly available data. In one implementation, the open hours information may be bolstered by a secondary database that also provides hours for establishments that are not listed online or cannot be found through web searches.

Provided is also a system for managing reservations, includes a reservation data server to store reservation data, the reservation data server further including a reservation processor to process the reservation data; and a vendor processor to process data from vendors; at least one point of sale (PoS) server coupled to the reservation data server to store data sent from at least one PoS; at least one device configured to send reservation data to the reservation data server and to receive processed reservation data from the reservation processor; and at least one vendor device configured to transmit data from vendors to the reservation data server.

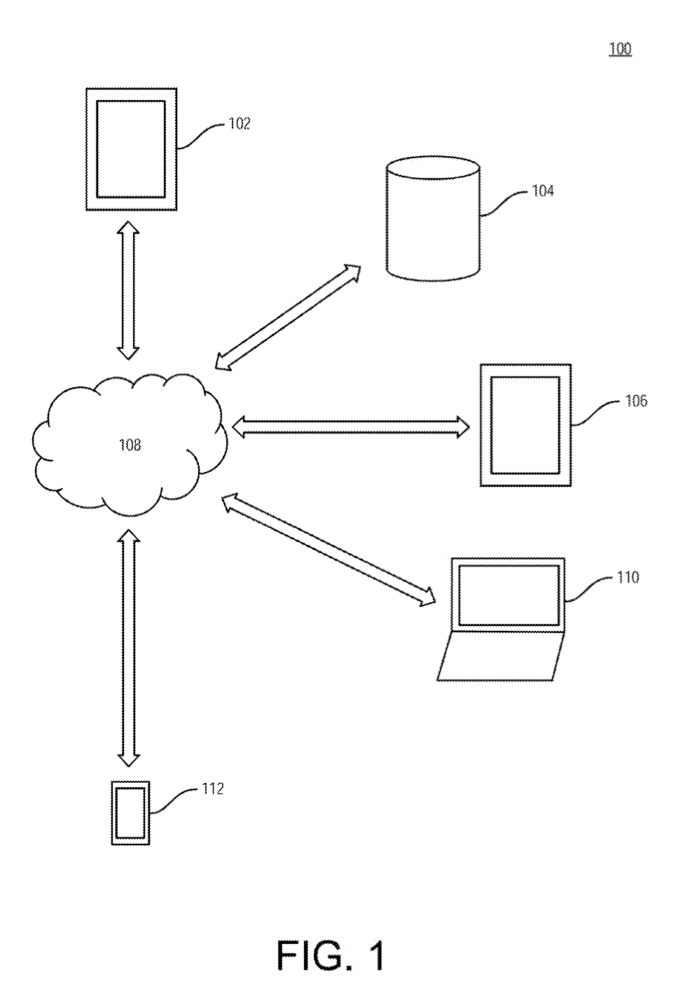

FIG. 1 shows a diagram 100 of various components used for a system to manage reservations, according to an aspect of the present disclosure. Diagram 100 includes a first host app 102, a host application program interface (API) 104, a second host app 106, an internet connection 108, a first user device 110, and a second user device 112. The first host app 102 can be a tablet device, computer, smartphone, computing device or similar device installed with the application using the system to manage reservations used by a host or restaurant. For example, the first host app 102 may be used by a quick service restaurant (QSR). The second host app 106 can also be a tablet device, computer, smartphone, computing device or similar device installed with the application using the system to manage reservations used, by another host or restaurant. For example, the second host app 106 may be used by a foil service restaurant (FSR). The first user device 110 can be a laptop, smartphone, computer, computing device or similar device installed with the application using the system to manage reservations used by a user. For example, the first user device 110 can be a personal computer or laptop computer connected to the internet 108 and used by a user. The second user device 112 can also be a laptop, smartphone, computer, computing device, or similar device installed with the application using the system to manage reservations used by a user. For example the second user device 112 can be a smartphone connected to the internet 108 and used by a user. The host API 104 can store code, data or other information used to interface the first host app 102 and the second host app 106 with the first user device 110 and the second user device 112. The first host app 102, the second host app 104, the first user device 110 and the second user device 112 are all coupled, connected to or linked to the internet connection 108, either wirelessly or via a physical wired connection.

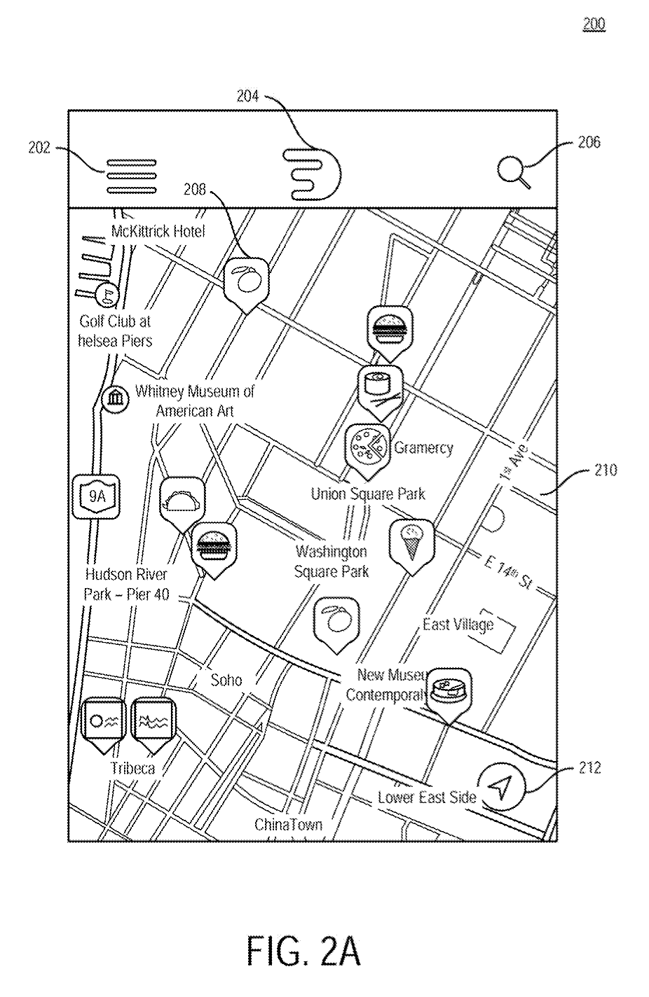

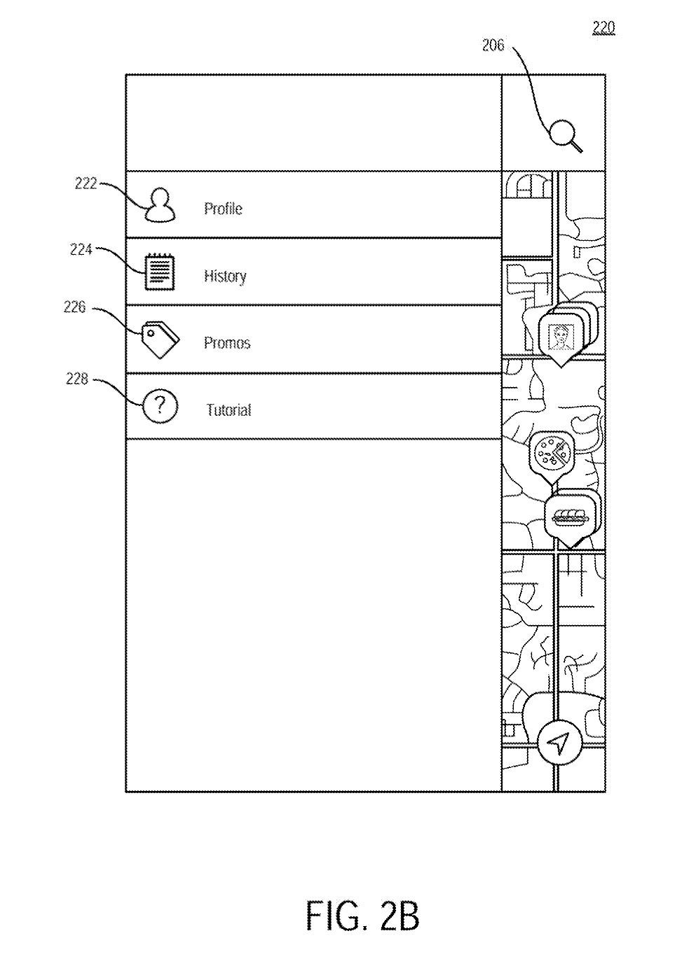

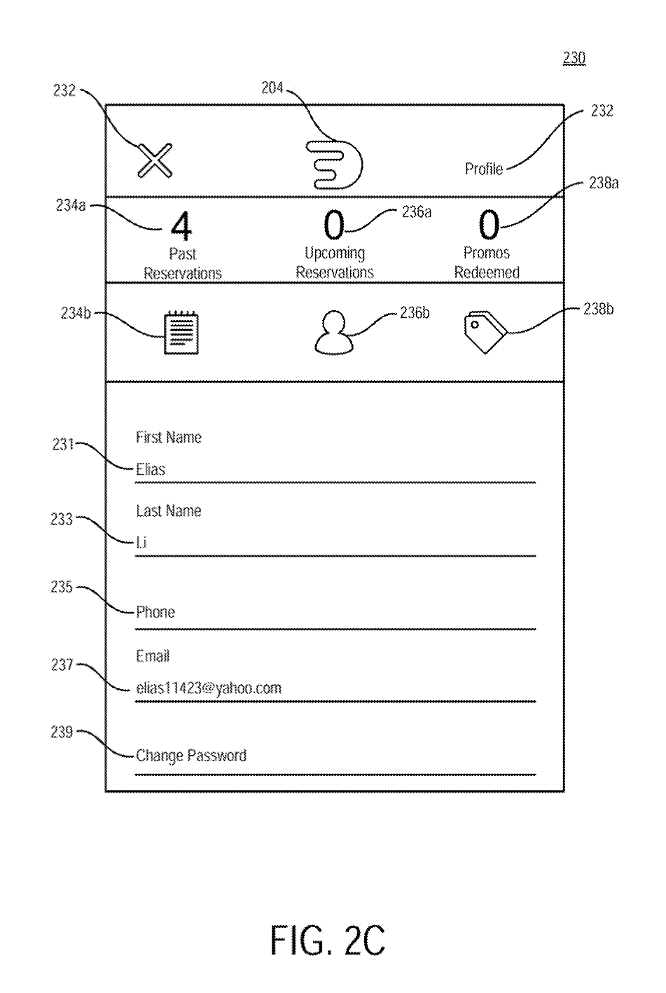

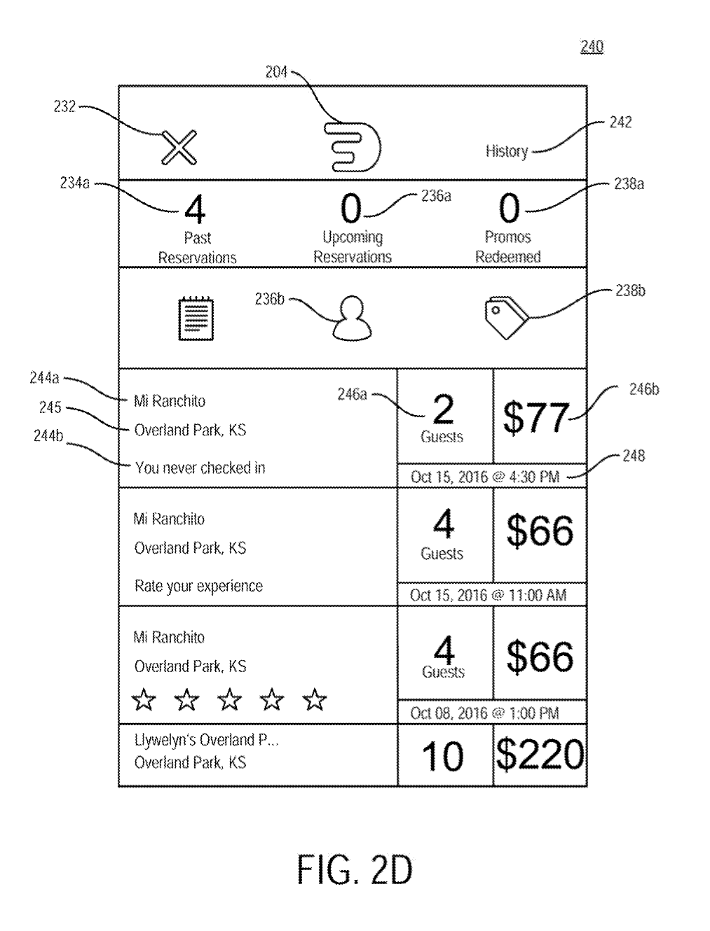

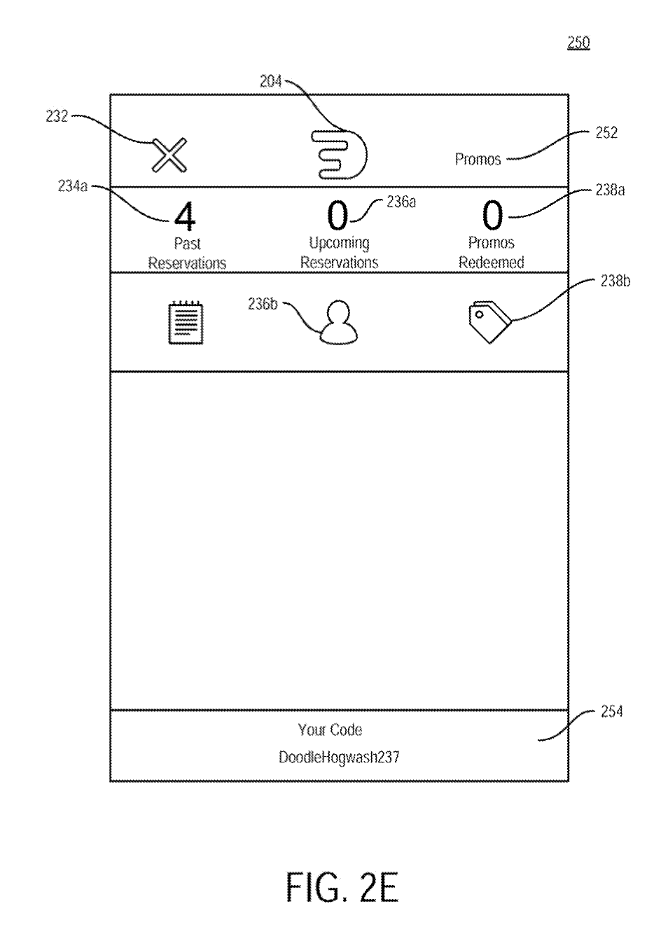

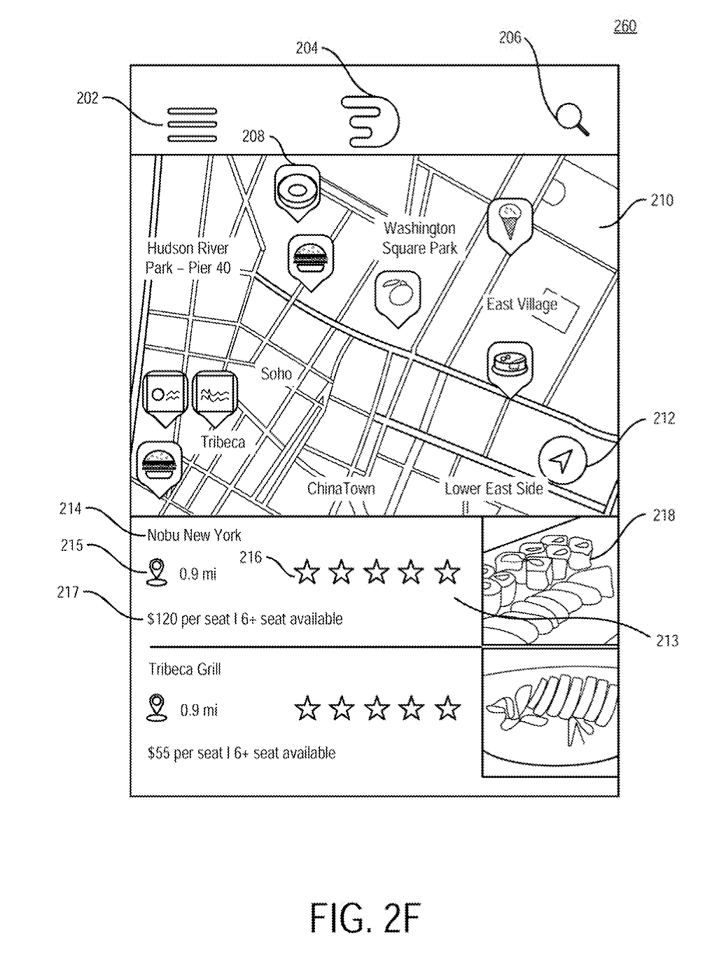

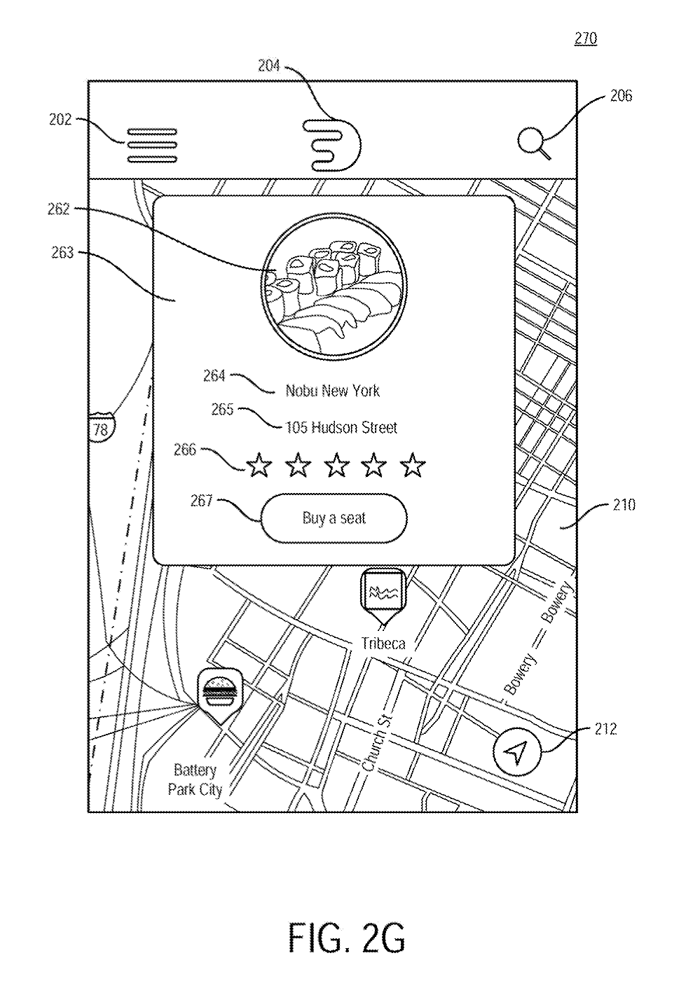

FIGS. 2A-2G show screenshots of an user application used by a system to manage reservations, according to an aspect of the present disclosure.

FIG. 2A is a screenshot 200 of a homepage of a user application (“user app”) using the system to manage reservations according to an aspect of the present disclosure. The screenshot 200 includes drop-down menu icon 202, logo 204, search icon 206, various host icons 208, a map 210 and a compass 212 used by the map 210. Clicking on the drop-down menu icon 202 will bring a user to the screenshot 220 shown in FIG. 2B, which will be described later. Clicking on the search icon 206 will bring a user to the screenshot 260 shown in FIG. 2F, and also allow the user to search for names, locations (addresses) and other information related to various hosts or restaurants. Clicking on the logo 204 clears the search history from using the search icon 206 to search. In one aspect, clicking on the logo 204 resets the user app. In one aspect, clicking on the logo 204 will bring up a feature for QSR ordering and will list which items each host has for sale, so that a user can order that exact menu item and it will be ready for the user to pick up, similar to an “order ahead” feature available from some restaurants. A host icon 208 represents a host or restaurant, and clicking on the host icon 208 will bring the user to screenshot 270 of FIG. 2G. The map 210 is an interactive, movable/scrollable map that loads and shows the geographic location of various hosts according to the present geographic location of the user, which may be ascertained by global positioning satellite (GPS) detection capabilities or other similar software. In one aspect, the user can search for all open hosts in a given radius on the map 210 based on their location. In one aspect, the user can also search for all hosts of a given type, or by hours, or by whether the host offers delivery, or by a variety of other factors. The compass 212 can be displayed on the map 210 to show the user which direction they are headed in relative to the various host icons 208. In one aspect, the display of the compass 212 can be turned on or off, or different styles of a compass (e.g. one showing North, South, East and West; another just showing an arrow) can be displayed.

FIG. 2B shows a screenshot 220 when the drop-down menu icon 202 is pressed from screenshot 200. As can be seen m screenshot 220, there is the search icon 206 from the previous screenshot 200, but there is also a profile icon 222, a history icon 224, a promos icon 226 and a tutorial icon 228. All the above mentioned icons may be represented by a pictoral graphic, the ones that am shown in FIG. 2B are merely for illustration and are also not limiting.

FIG. 2C shows a screenshot 230 when the profile icon 222 is clicked from screenshot 220 of FIG. 2B. Screenshot 230 includes a cancel icon 232, the logo 204, a current page display 232, a past reservations display 234a, and a past reservations graphic 234b, an upcoming reservations display 236a and an upcoming reservations graphic 236b, and a promos redeemed display 238a as well as a promos redeemed graphic 238b. Screenshot 230 also shows a user first name 231, a user last name 233, a user phone number 235, a user email address 237 and a change password icon 239. Cancel icon 232, when clicked, cancels the current screenshot 230 and returns the user to screenshot 200 of FIG. 2A in another aspect. In one aspect, clicking on the cancel icon 232 returns the user to screenshot 220 of FIG. 2B. Logo 204 performs the same functionality as described above. In one aspect, logo 204 clears the user provided data shown in screenshot 230, such as the fields 231, 233, 235, 237 and also possibly the password which may be changed via 239. The current page display 232 displays what current page the user is on, in this case the “profile” page. Past reservations display 234a shows the number of past reservations made to the user, and has an accompanying graphic 234b. Upcoming reservations display 236a shows the number of upcoming reservations that the user can make to the user, and has an accompanying graphic 236b. Promos redeemed 238a shows the number of promotions redeemed by the user and also has an accompanying graphic 238b. In one aspect, clicking on the graphics 234b, 236b or 238b will take the user to separate pages (not shown) describing more information about past reservations, upcoming reservations and promotions redeemed by/from the user, respectively. The fields shown in 231, 233, 235 and 237 are self-explanatory and can be changed or modified by the user upon clicking on them. Clicking on the change password icon 239 takes the user to a separate page (not shown) or a pop-up (not shown) where the user is prompted to change his/her password or presented with other functionality (also with a Captcha-test for added security) in order to change his/her password to login to the user app.

FIG. 2D shows a screenshot 240 when the history icon 224 is clicked from screenshot 220 of FIG. 2B. Screenshot 240 shows the cancel icon 232, the logo 204 (with the same functionality as described above) and current page display 242, which shows that the user is currently on the “history” page. Elements 234a-b, 236a-b and 238a-b are also the same as described previously. Screenshot 240 also shows rows of previous reservation history entries 245, each previous reservation history entry 245 including a previous host name 244a, a previous host status 244b, a guest number 246a, a cost 246b and a reservation time 248. Previous host name 244a is the name of a previous host visited by the user during a previous reservation. Previous host status 244b reveals either a rating (as can be seen by the third reservation history entry down), a link to a page (not shown) or pop-up (not shown) where the user can rate their experience during the reservation by a system e.g. on a scale out of 5 stars, or a status indicator reflecting that the user has never checked into a host. Guest number 246a shows the number of guests the user went to the host with during a prior reservation, including themselves. Cost 246b shows the amount the user paid when they visited that host during that prior reservation. Reservation time 248 shows the date and time in which the user made that previous reservation, and also the time they subsequently attended that reservation. In one aspect, a different reservation and attendance time may be shown.

FIG. 2E shows a screenshot 250 when the promos icon 226 is clicked from screenshot 220 of FIG. 2B. Screenshot 250 shows cancel icon 232, logo 204, current page display 252 (showing that the user is at the “promos” page) and elements 234a-b, 236a-b and 238a-b as described above. Screenshot 250 also shows a promo code 254, which the user can redeem in order to receive promotions or promotional discounts at various hosts or during special events or sales. These promotions are also controlled by in time demand factors, which observe the demand of a current vendor at the current time. Furthermore, a vendor may pull or remove any promotion whenever they wish, and a vendor may specify that a promotion is only valid for a limited period of time.

FIG. 2F shows a screenshot 260 when the search icon 206 is pressed from screenshot 200 of FIG. 2A or screenshot 220 of FIG. 2B. Elements 202, 204, 208, 210 and 212 are the same as described for screenshot 200 of FIG. 2B. Screenshot 260 further shows several host entries 213, each host entry 213 including a host name 214, a host location 215, a host rating 216, a host reservation price 217, and a host image 218. The host name 214 is the name of the host. The host location 215 is either a geographic location (e.g., coordinates), address or distance marker/indicator displaying the distance from the user's current location to the host. The host rating 216 is a rating given on a scale (e.g., out of 5 stars) given by the user on a previous reservation. In one aspect, the host rating 216 can be an aggregate or average rating based on the ratings of several users. In one aspect, this average rating can be taken over connections via a social networking website or app. The host reservation price 217 is the cost of a reservation (which can be shown as per seat or per table or another metric) at the host. The host reservation price 217 also displays the number of seats that may be currently available at the host. The host image 218 is an image associated with the host for example, a picture of a dish or other menu item served by a host, if the host is a restaurant, or an image of an activity (e.g., rock climbing wall, batting cage, pet being groomed, car being sold) if the host is a service, store or facility that offers a service, experience or activity or sells a certain type of product.

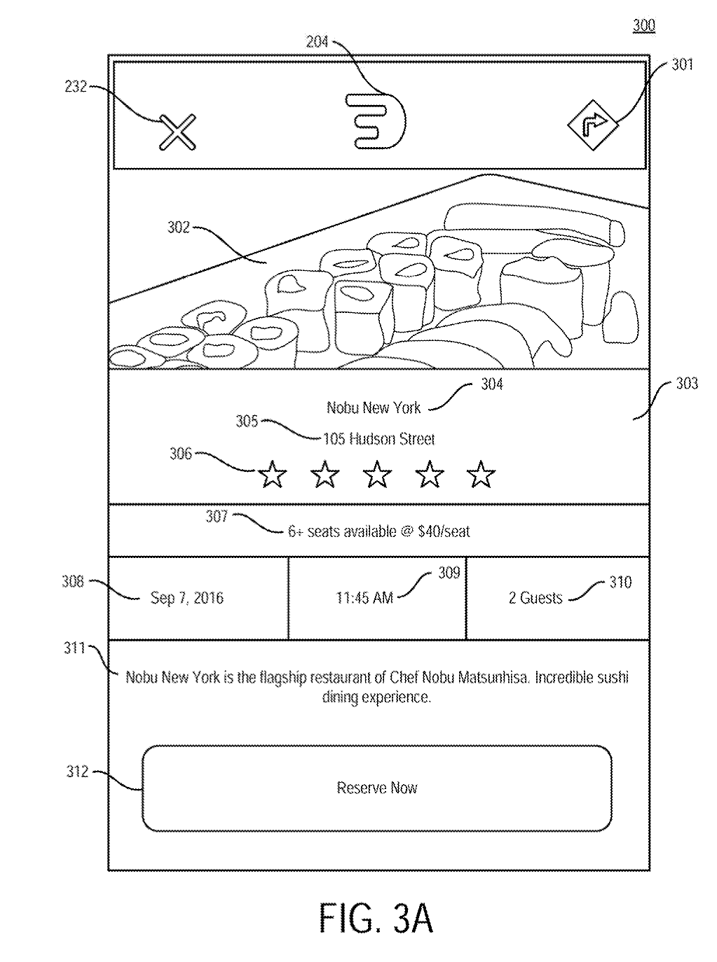

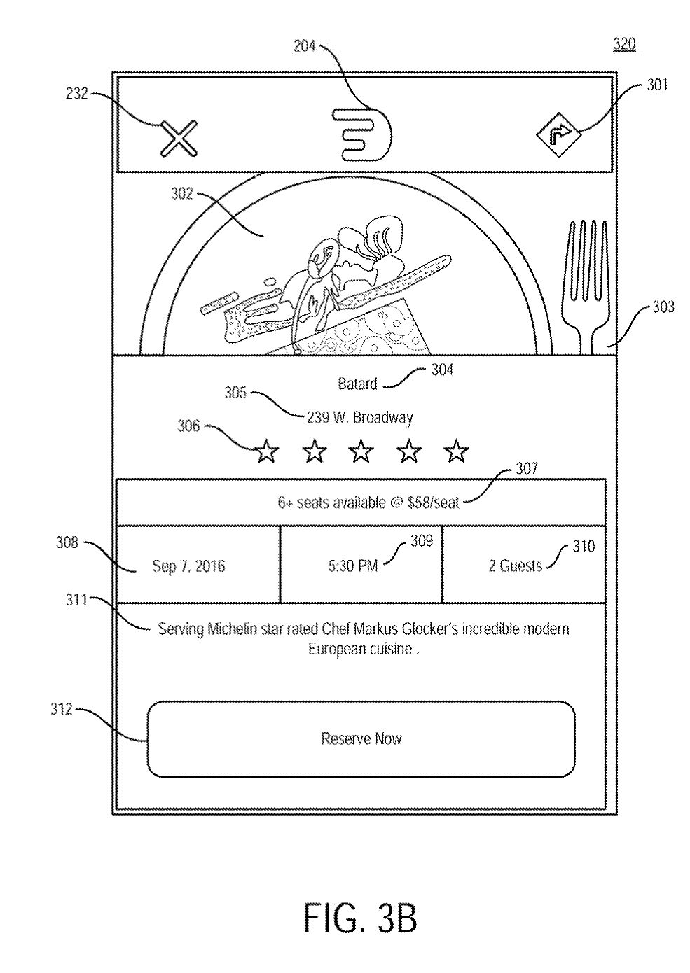

FIG. 2G shows a screenshot 280 when a host icon 208 is clicked from screenshot 200 of FIG. 2A or screenshot 260 of FIG. 2F. Elements 202, 204, 206, 210 and 212 are the same as described above. Screenshot 280 shows host popup 263 which includes host pop-up image 262, host pop-up name 264, host pop-up address 265, host pop-up rating 266 and host pop-up reservation icon 267. The host pop-up image 262 is a representative image of the host (e.g., menu or entree item if the host is a restaurant), the host pop-up name 264 is the name of the host, the host pop-up address 265 is the address of the host (in one aspect, a geographic marker showing the distance from the user's current location to the host may be displayed in lieu of or in addition to the host pop-up address 265), and the host pop-up rating 266 is a rating of the host (in one aspect, the host pop-up rating 266 could be a prior user rating of the host, or an aggregate or average of multiple user ratings, either taken across all users or only via users seen locally or connected to the present user via a social network). The host pop-up reservation icon 267 leads the user to screenshot 300 of FIG. 3A and screenshot 320 of FIG. 3B, which will be described below.

FIGS. 3A-3B show other screenshots, after certain icons are pressed, of an user application used by a system to manage reservations, according to an aspect of the present disclosure.

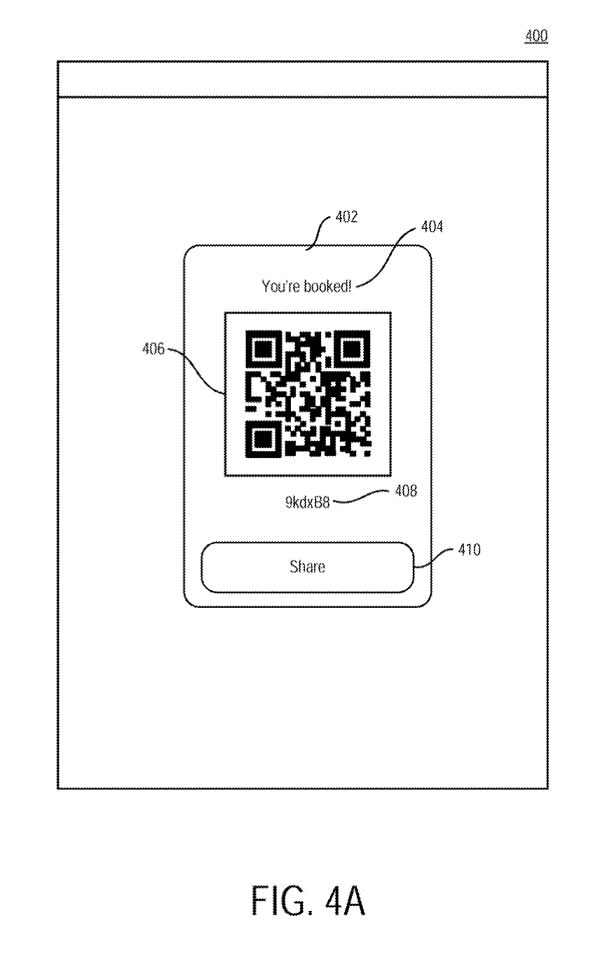

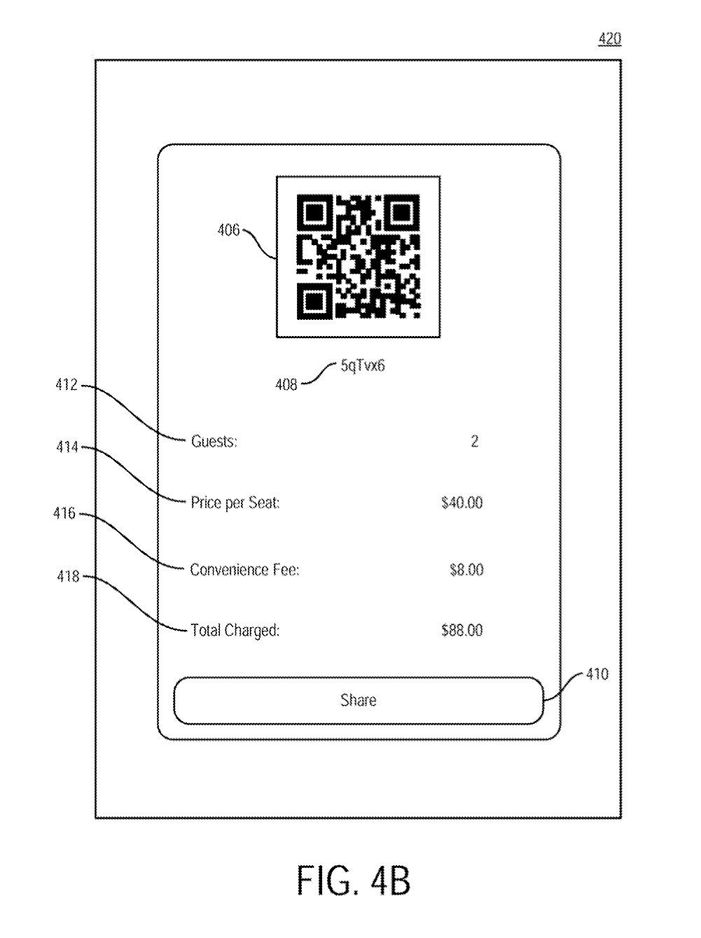

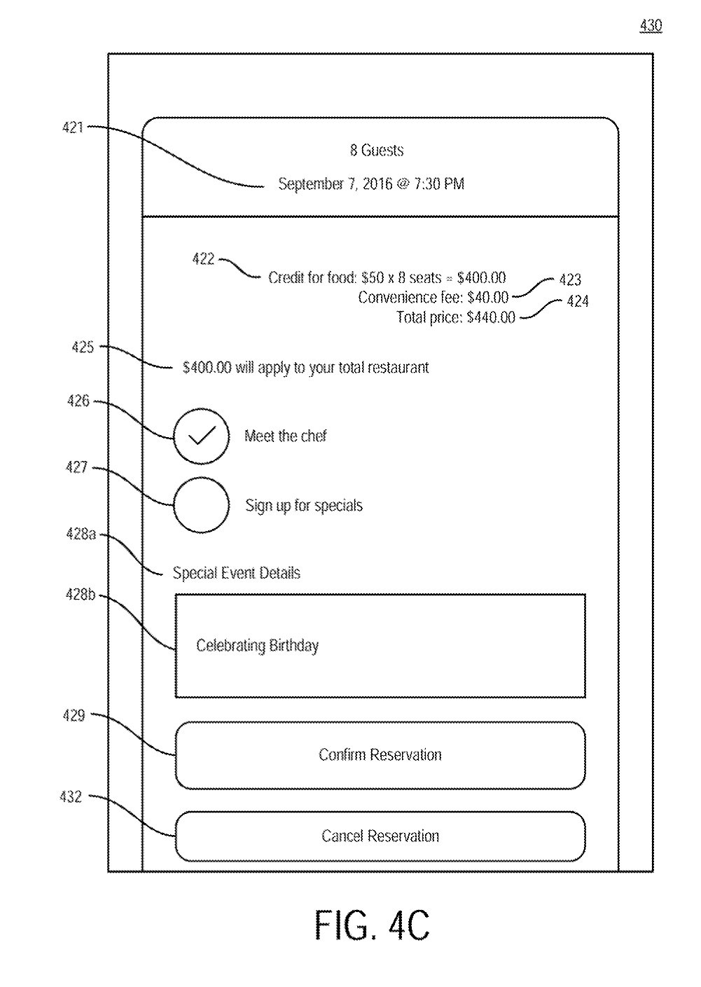

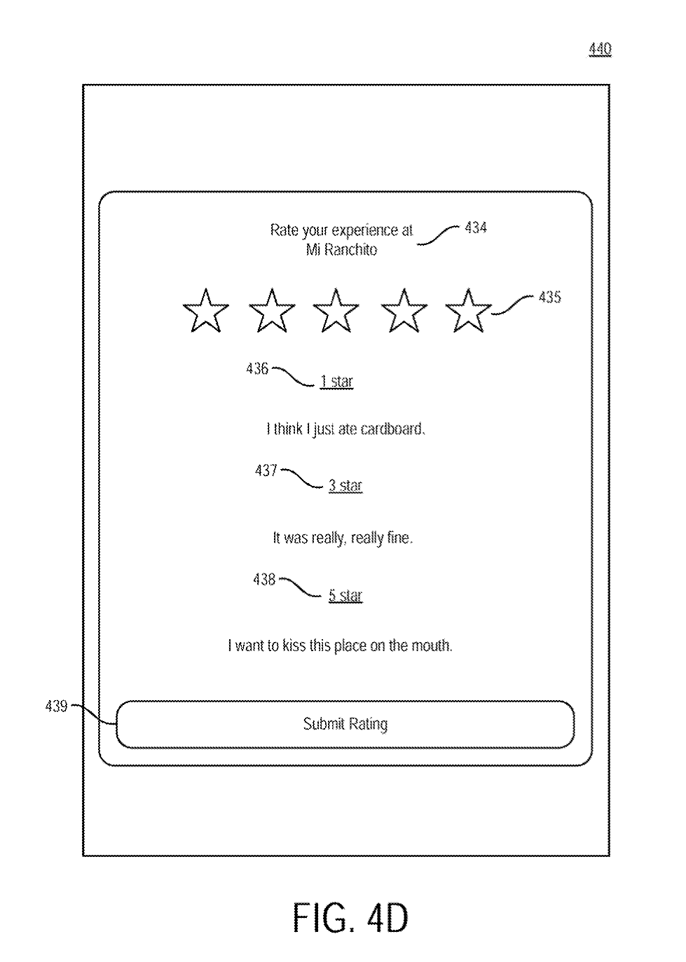

FIG. 3A shows a screenshot 300 of a host page according to an aspect of the present disclosure. Screenshot 300, which also includes elements 232 and 204 discussed previously, shows a return icon 301, a blown-up host image 302, a host transparent screen 303 including a host name 304, a host address 305, a host rating 306, a host seat availability and pricing display 307, a reservation date 308, a reservation time 309, a reservation guest number 310, a host description 311 and a reserve now button 312. The return icon 301, when clicked, can return the user to screenshot 200 of FIG. 2A or in another aspect, to screenshot 270 of FIG. 2G. Blown-up host image 302 is a larger version of a representative. The host image of the host, such as a menu or entrée item if the host is a restaurant. The host transparent screen 303 includes the host name 304, which is the name of the host, the host address 305, the address of the host (in one aspect, there can be a geographic marker showing the distance from the user's current location to the host in lieu of or in addition to the host address 305), and the host rating 306 which is the user's prior rating of the host (in one aspect, the host rating 306 can be an aggregate or average rating across all users or only a certain subset of users as delineated by a social network). The host transparent screen 303 also includes the host availability and pricing display 307, which shows the number of seats or tables available at the host and also the price or cost of a seat or table at the host (in one aspect, the seats or tables can be appointment slots if the host is a facility offering a service or activity), the reservation date 308, the reservation time 309 and the reservation guest number 310, which show the date, the time and the number of requested seats for the requested reservation—which can be modified or selected by the user via a pop-up numerical, text and/or scroll-down menu (not shown) that appears when the respective element 308, 309 or 310 is pushed or clicked. Host description 311 is a paragraph long or a few-sentence long description of the host. The reserve now button 312 takes the user to screenshot 400 of FIG. 4A, or in one aspect, to screenshot 420 of FIG. 4B.

FIG. 3B shows a screenshot 320 that is similar to the screenshot 300, with the exception of elements 302, 304, 305, 306, 307, 308, 309, 310 and 311 being different by virtue of screenshot 320 showing a different reservation being made for a different host.

FIGS. 4A-4D show yet other screenshots, after certain icons are pressed, of a user application used by a system to manage reservations, according to an aspect of the present disclosure.

FIG. 4A shows a screenshot 400 which appears after the reserve now button 312 of FIGS. 3A-3B is pressed, and shows a hooking confirmation window 402, which includes a booking confirmation text 505, a booking confirmation quick response (QR) code 406, a booking confirmation code 408 and a booking confirmation share button 410, all relevant, to a reservation that was made at the host at a certain date and time and seat number, etc., via FIGS. 3A-3B. The booking confirmation window 402 can be a pop-up or transparent window that shows up in screenshot 400 when the reserve now button 312 is pressed from FIGS. 3A-3B. The booking confirmation text 505 is a string of text that expresses that a booking or reservation for a date and time and a seat number, etc., has been made at the host, e.g., “You're hooked!” as shown in screenshot 400 of FIG. 4A. The booking confirmation QR code 406 is a code that when taken a picture of via a camera (on a smartphone, for example) or picked up or received or scanned by any type of scanner (which may be available on a smartphone), subsequently takes a user to screenshot 440 of FIG. 4D, where a rating can be entered for the host that the reservation was made for and previously experienced by the user. In one aspect, scanning the booking confirmation QR code 406 takes the user to a webpage showing the booking confirmation of a reservation (not shown). The booking confirmation code 408, like the booking confirmation QR code 406, also takes the user to screenshot 440 of FIG. 4D, where a rating can be entered for the host that the reservation was made for and previously experienced by the user, when the booking confirmation code 408 is input into a field of a webpage, or asked by a field in a webpage, or by phone or by another system. In one aspect, once the user inputs the booking confirmation code 408 as described above, they are also taken to a webpage showing the booking confirmation of a reservation (not shown). The share button 410 shares the booking confirmation via a social network page, so that when connections of a user in a social network click on the link generated after the user clicks the share button 410, they are taken to a webpage showing the booking confirmation of a reservation. In one aspect, the webpage showing the booking confirmation may look similar to FIG. 4A. in one aspect, the QR code 406 can be used as a ticket to an event such as a concert, or expo. In addition to or instead of a QR code 406, other identifying data can be used for ticketing for an event, such as a barcode, a passcode, a confirmation number, a confirmation word, a confirmation image and any other image or code identifying that the user purchased a ticket.

FIG. 4B shows another screenshot 420 which appeal's after the reserve now button 312 is pressed from FIGS. 3A-3B. Screenshot 420 also includes the booking confirmation QR code 406, the booking confirmation code 408 and the share button 410 from screenshot 400 of FIG. 4A, as described above. Screenshot 420 further includes a guest number 412, a price per seat 414, a convenience fee 416, and a total charge amount 418. The guest number 412 displays the number of guests in a reservation made at a host. The price per seat 414 shows the price paid per seat in a reservation made at a host. The convenience fee 416 shows an additional fee charged to the user who makes a reservation at the host. In one aspect, the host may decide the amount of the convenience fee 416, and the convenience fee 416 may vary depending on the host and the type of host. The total charge amount 418 reflects the total amount charged to the user, which adds the convenience fee 416 with the price per seat 414 multiplied by the guest number 412. In the example shown in screenshot 420, an $8 convenience fee 416 is added to the guest number 412 (2) multiplied by the price per seat ($40) to obtain a total charge amount 418 of $88,00. The share button 410 of screenshot 420 is similar to the share button 410 of screenshot 400 however in one aspect, the webpage showing the booking confirmation may also show the data reflected by elements 412, 414, 416 and 418, such as something similar to, for example, screenshot 430 of FIG. 4C, as shown below.

FIG. 4C shows yet another screenshot 430 which appears after the reserve now button 312 is pressed from FIGS. 3A-3B. Screenshot 430 includes guest and date-time data 421, food credit amount 422, convenience fee 423, total price amount 424 and total applied amount 425. Screenshot 430 also includes a meet the chef radio button 426, a sign up for specials radio button 427a, a special events details text 428b, a special events details field 428b, a confirm, reservation button 429 and a cancel reservation button 432. The guest and date-time data 421 reflects the number of guests, the date and the time of the reservation the user has made with the host, after pressing or clicking the reserve now button 312 from FIGS. 3A-3B. The food credit amount 422 reflects the total price amount when the amount of seats is multiplied by the price per seat; in the example shown in screenshot 430, a price per seat of $50 is multiplied by 8 seats to arrive at an amount of $400. The food credit amount 422 is also the amount of money that the user will have to pay towards food at a restaurant or for a service at another type of host. The convenience fee 423 is similar to the convenience fee 416 described above for screenshot 420, and can be a variable amount that is set by the host. The total price 424 is also similar to the total charge amount 418 of screenshot 420, and is the total amount derived when summing together the food credit amount 422 and the convenience fee 423: in screenshot 430, the total price 424 of $440 is derived by adding together the food credit amount 422 of $400 with the convenience fee 423 of $40. The total applied amount 425 is an amount that may be a credit or promotion that applies to the total price 424, so that the user may be able to pay less for food or for a service. The variable fee paid here is not a mere reservation but a pre-payment that goes directly to the vendor, and is already paying for a reservation, event or meal, versus telling the vendor to reserve a spot (which can be cancelled at any moment). In this regard, the vendor receives the payment already and does not need to worry about users who cancel.

The meet the chef radio button 426, when selected, allows the user to select a “Meet the Chef” feature. In one aspect, the Meet the Chef feature allows the user to meet with a chef of the host, or another VIP person who works for the host (e.g., executive, director, CEO, guide, trainer, worker or professional) for a special meeting that only the user of the application using the system for managing reservations has access to. In one aspect, instead of a meet the chef event, the event can be instead a meet the founder event, a fundraising event, a birthday party, a wedding, a bachelor's party, a religious party event, a business presentation, a business meeting, an internal company event and a networking event, or any other similar event. The sign up for specials radio button 427, when selected, allows the user to sign up for specials or promotions that can be emailed, text messaged, mailed or delivered to the user by a variety of different methods. The special event details text 428a is text that is customizable by a host, for example, prompting the user to enter details for a special event, or special requests for the reservation, or any miscellaneous comments (in the example of screenshot 430, the text “Special Event Details” is shown as the special event details text 428a). The special event details field 428b is a user-fillable box where the user can input or type text reflecting what is requested by the special event details text 428a, such as details for a special event, special requests for the reservation, or any other miscellaneous comments. The confirm reservation button 429, when pressed, confirms the reservation and sends the data input and selected by the user in elements 421-427 and 428a-b to the system for managing reservations. The cancel, reservation button 432, when pressed, cancels the reservation and can bring the user back to a different page, e.g., in one aspect, the user is returned to screenshots 300 or 320 of FIG. 3A or FIG. 3B for example, or another similar screenshot.

FIG. 4D shows screenshot 440 that the user sees after pressing, for example, element 244b in screenshot 240 of FIG. 4D. In one aspect, screenshot 440 appears after the user presses element 216 of screenshot 260 in FIG. 2F, and/or element 266 in screenshot 270 of FIG. 2G, and/or element 306 in screenshots 300 and 320 of FIGS. 3A and 3B, which in addition to displaying the rating allows the user to click and access a screen to provide a rating, which is screenshot 440. Screenshot 440 also includes a rating title 424, a rating scale 435, a first rating scale amount 436, a second rating scale amount 437, a third rating scale amount 438 and a submit rating button 439. The rating title 424 displays text to the user prompting them to provide a rating for a given host, in this case, to rate their experience at a restaurant called “Mi Ranchito”. The rating scale 435 is a scale that the user can select a number out of in order to indicate their rating. In the case shown, the rating is out of five stars, and the user clicks on a certain star out of the five stars in order to provide a rating (e.g., 1 star out of 5, 2 stars out of 5, 3 star's out of 5, 4 stars out of 5 or 5 stars out of 5). In one aspect, there may be other ranking scales used, such as letter grades, numbers or so on. In one aspect, ½, ¼ or fraction amounts less than one may be used for numerical ranking scales, so a rating of 3½ stars or 3.5 may be recorded. The first, second and third rating scale amounts 436, 437 and 438 indicate what different numbered ratings mean on the scale with displayed text describing what a user may describe an experience at a host was like, based on their rating. In the case shown, only three rating scale amounts are shown (1 star, 3 star and 5 star), but in one aspect, there could be any number of rating scale amounts shown, including none or all of the rating scale amounts. If the user clicks on the submit rating button 439, the rating is submitted to the system managing reservations and reflected in elements such as, for example, element 244b in screenshot 240 of FIG. 4D, element 216 of screenshot 260 in FIG. 2F, element 266 in screenshot 270 of FIG. 2G, and/or element 306 in screenshots 300 and 320 of FIGS. 3A and 3B. The user may also return to whatever previous screenshot they were at before providing their rating for the host on screenshot 440, which may be any of the above-described screenshots, e.g., screenshot 240 of FIG. 4D, screenshot 260 of FIG. 2F, screenshot 270 of FIG. 2G, and/or element 306 in screenshots 300 and 320 of FIGS. 3A and 3B, or other possible similar screenshots that show a rating scale that can be clicked, whereupon the user may or may not be brought to screenshot 440 of FIG. 4D to enter a rating for a host.

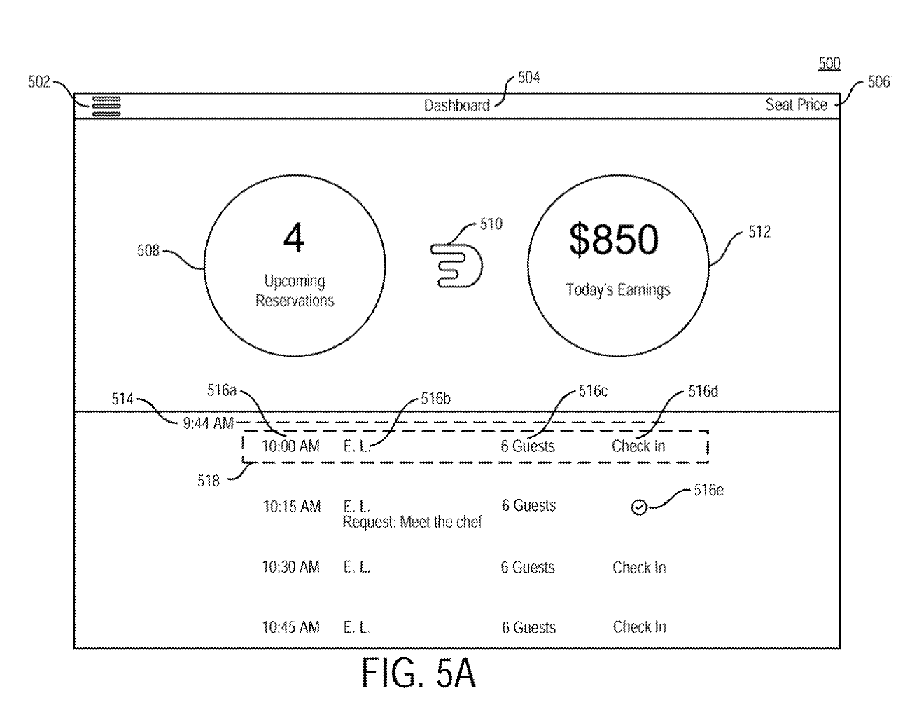

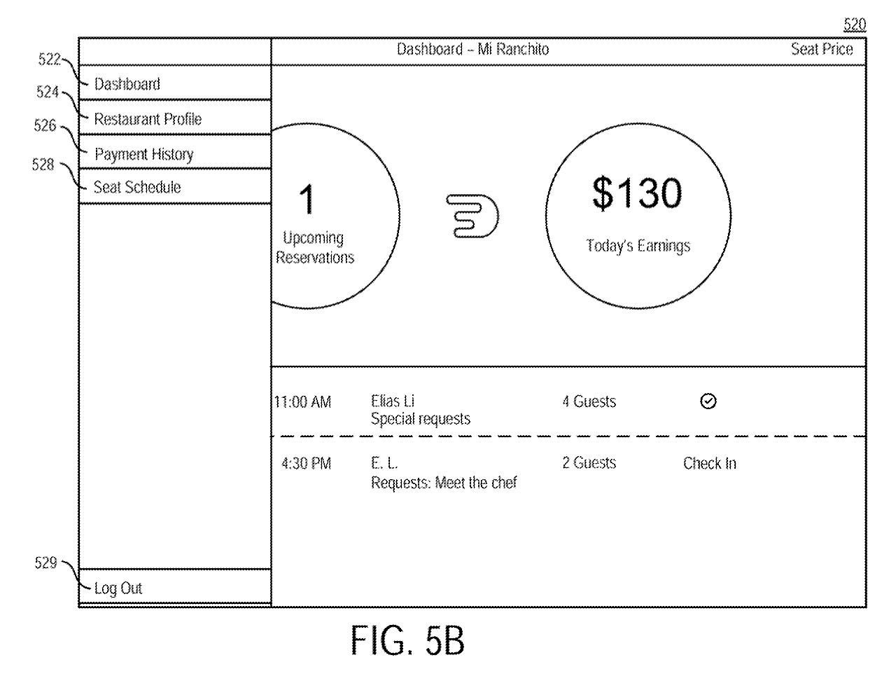

FIGS. 5A-5B show homepage screenshots of a host application used by a system to manage reservations, according to an aspect of the present disclosure.

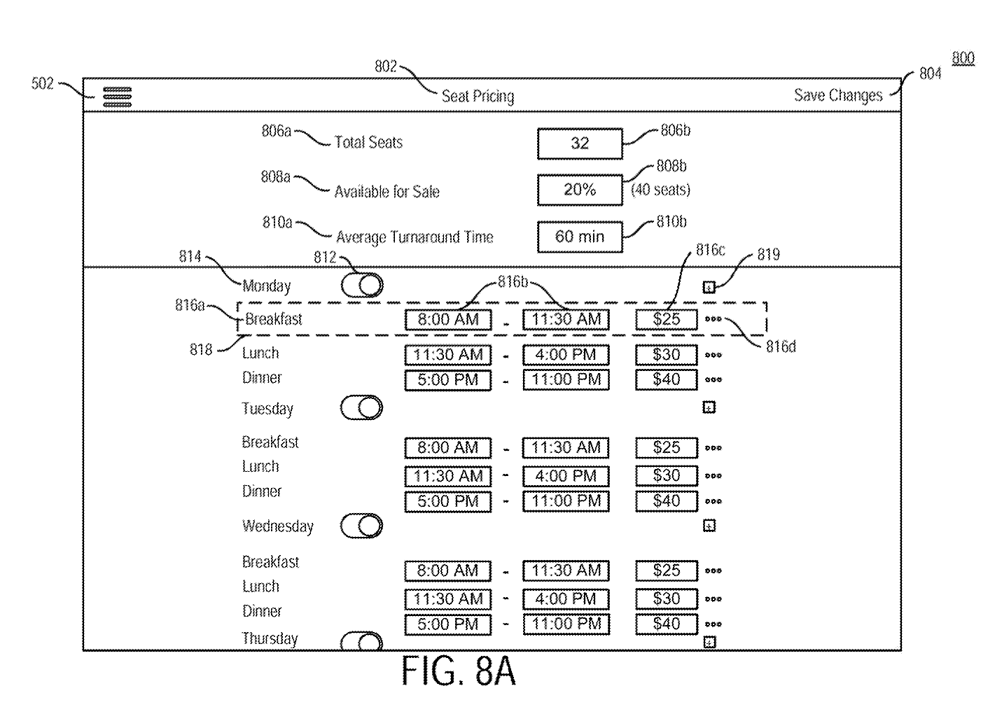

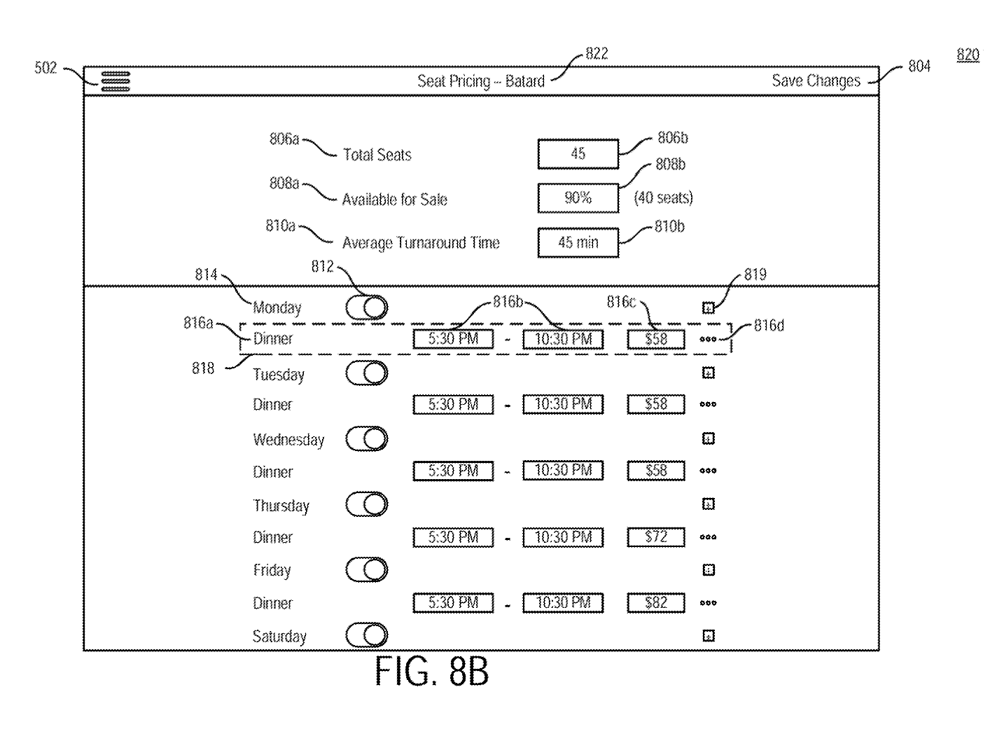

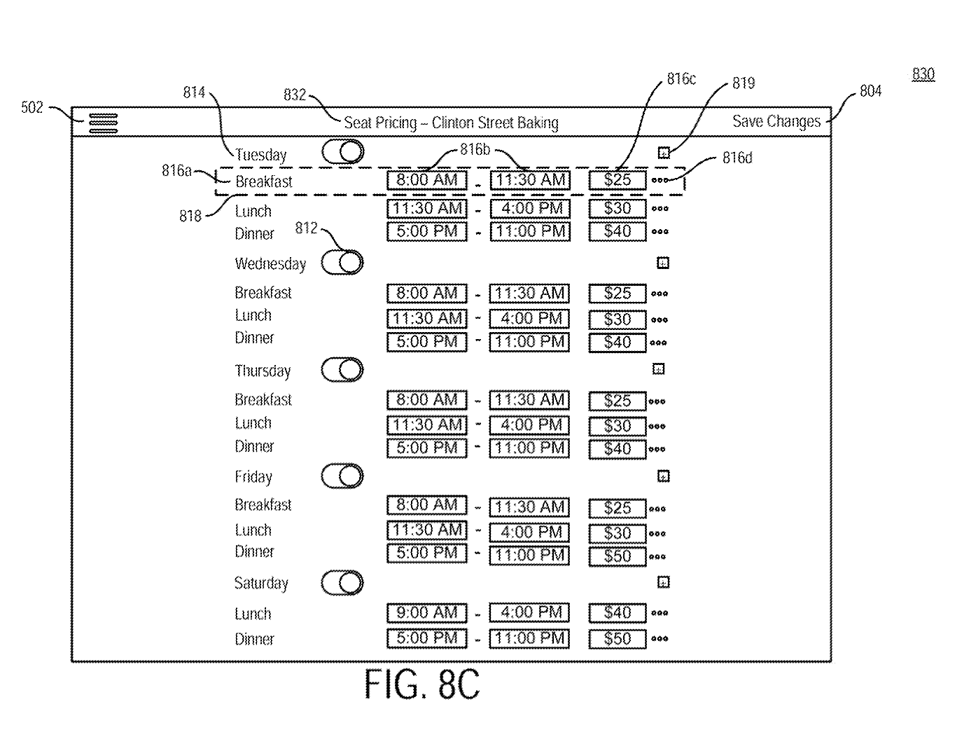

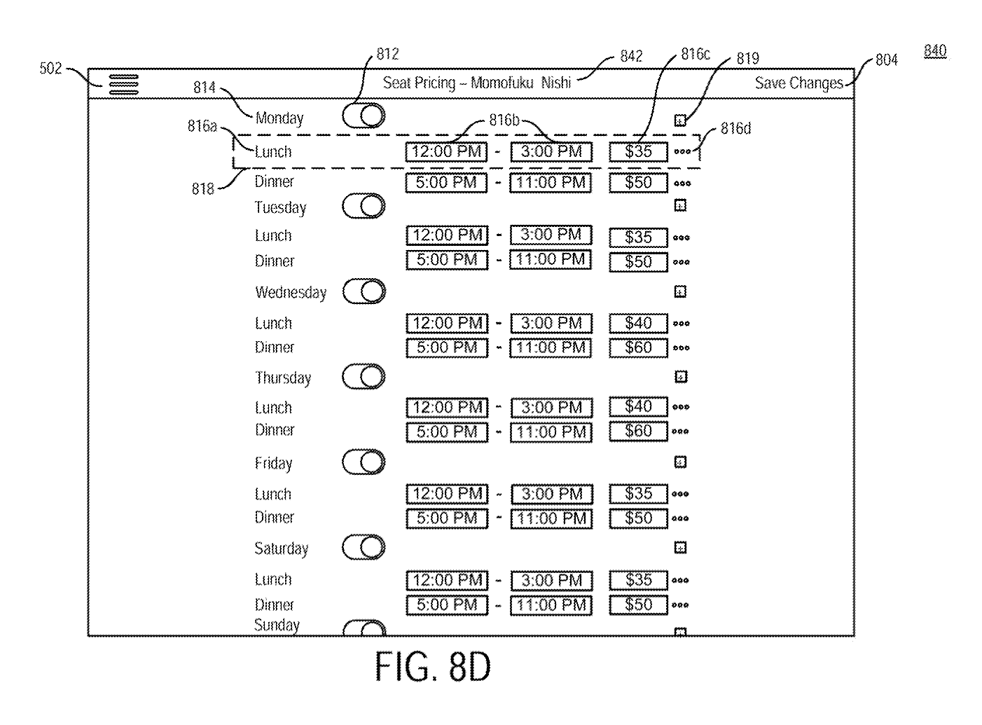

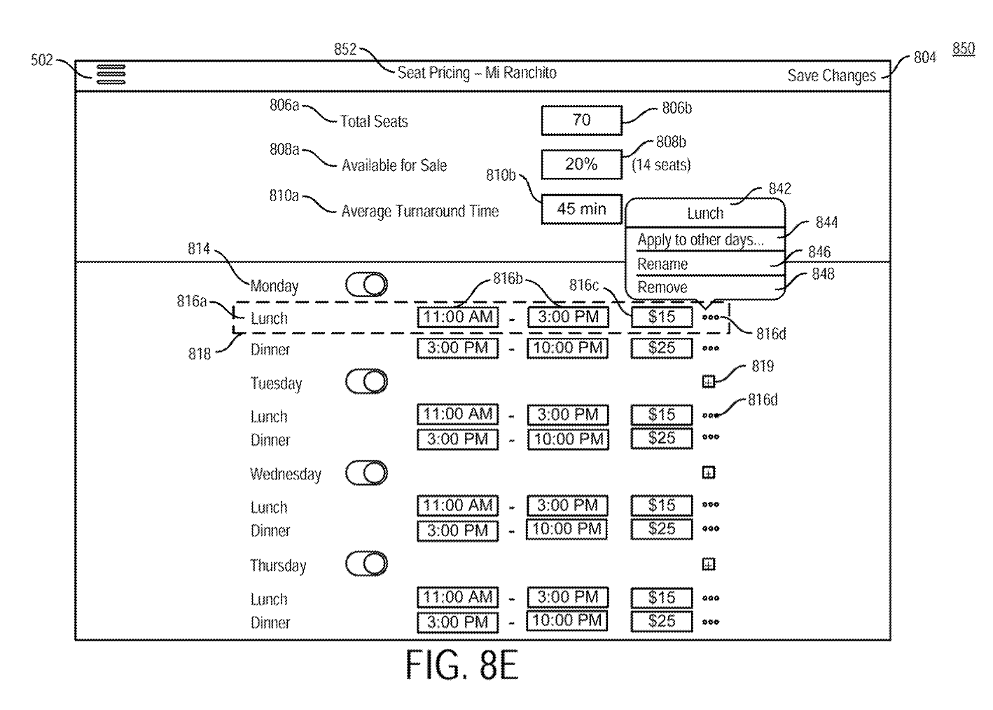

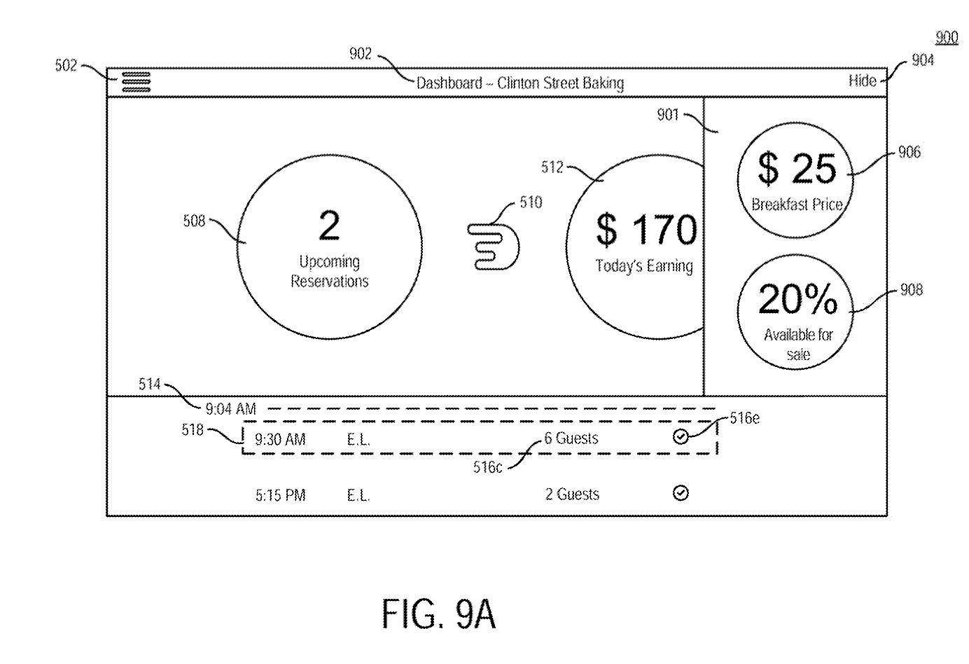

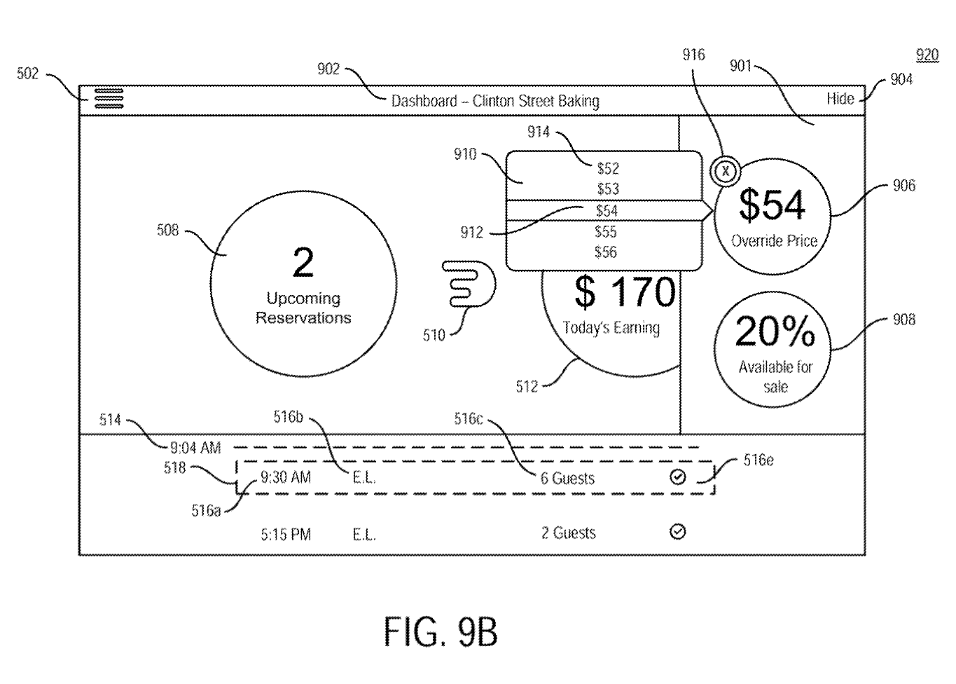

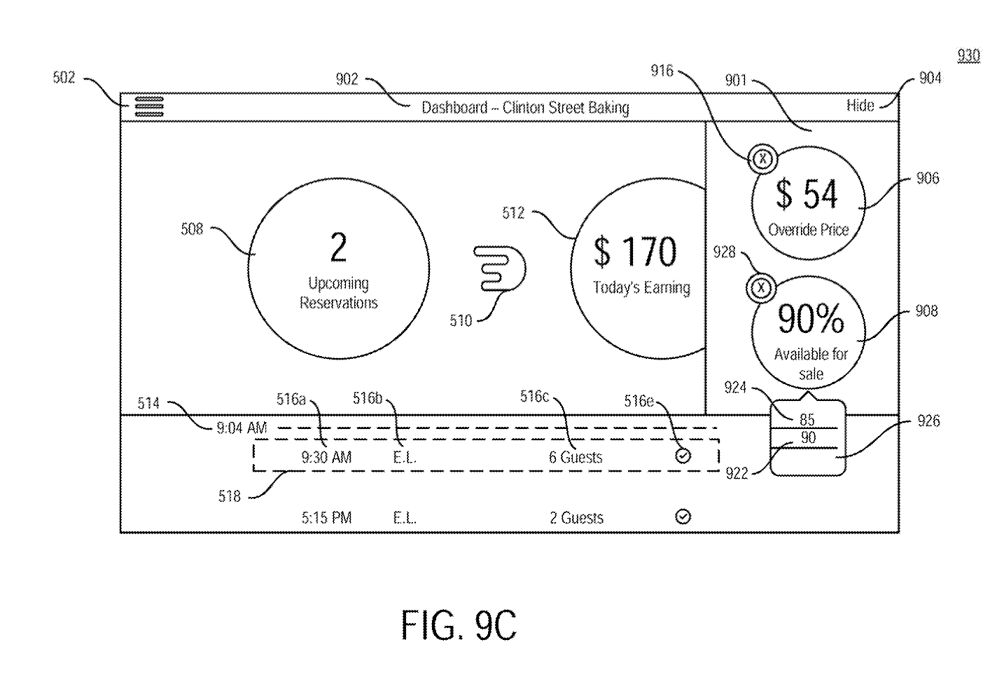

FIG. 5A shows screenshot 500 which is the “homescreen”, “homepage”, “dashboard”, landing page or first screen seen by the host on the host end of the app using the system for managing reservations. Screenshot 500 includes drop-down menu icon 502, current screen label 504, seat price icon 506, upcoming reservations 508, logo 510, daily earnings 512, time cutoff 514, a reservation entry 518 including a reservation time 516a, a reserving user ID 516b, a guest number 516c, a check in text 516d and occasionally a check in complete icon 516e. When drop-down menu icon 502 is clicked, the host is brought to screenshot 520 of FIG. 5B. The current screen label 504 displays text to the host describing what screen, is currently shown, in this case “Dashboard” is shown indicating that the dashboard is currently shown. In one aspect, the text of the current screen label 504 can display the text “homepage”, “homescreen”, “landing page” or similar text. The seat price icon 506, when clicked by the host, makes a pop-up—such as seat price pop-up 901—appear as shown in screenshot 900 of FIG. 9A, screenshot 920 of FIG. 9B, and screenshot 930 of FIG. 9C. In one aspect, clicking on the seat price icon 506 may take the host to screenshots 800, 820, 830 and 840 of FIG. 8. The upcoming reservations 508 displays a number reflecting the upcoming reservations the host needs to be aware of. The logo 510, when clicked, does nothing. In one aspect, clicking on the logo 510 may refresh the history of the reservation entries 518, each reservation entry 518 being shown by elements 516a-d and occasionally 516e. The daily earnings 512 displays how much money was earned in a total day, with the amount of time reflecting a day being set by the app using the system to manage reservations. In one aspect, the amount of time reflecting a day can be customized by the host. The time cutoff 514 is a time when the host begins taking reservations. In one aspect, another time cutoff (not shown) can denote when the host stops taking reservations. The reservation entry 518 includes the reservation time 516a—which sho ws the time of the reservation, the reserving user ID 516b—which reflects the name, username or other identifying information of the user who made the reservation, the guest number 516c—which shows the number of guests in a reservation, and the check in text 516d—which, when clicked by the host, can effectively notify the app using the system for managing reservations that the user and his/her guests have checked in. After the host clicks the check in text 516d when the user and his/her guests have checked in, a check in complete icon 516e (which may be in the form of a checkmark or similar symbol) appears, denoting to the host that the riser and his/her guests for a given reservation entry 518 has checked in.

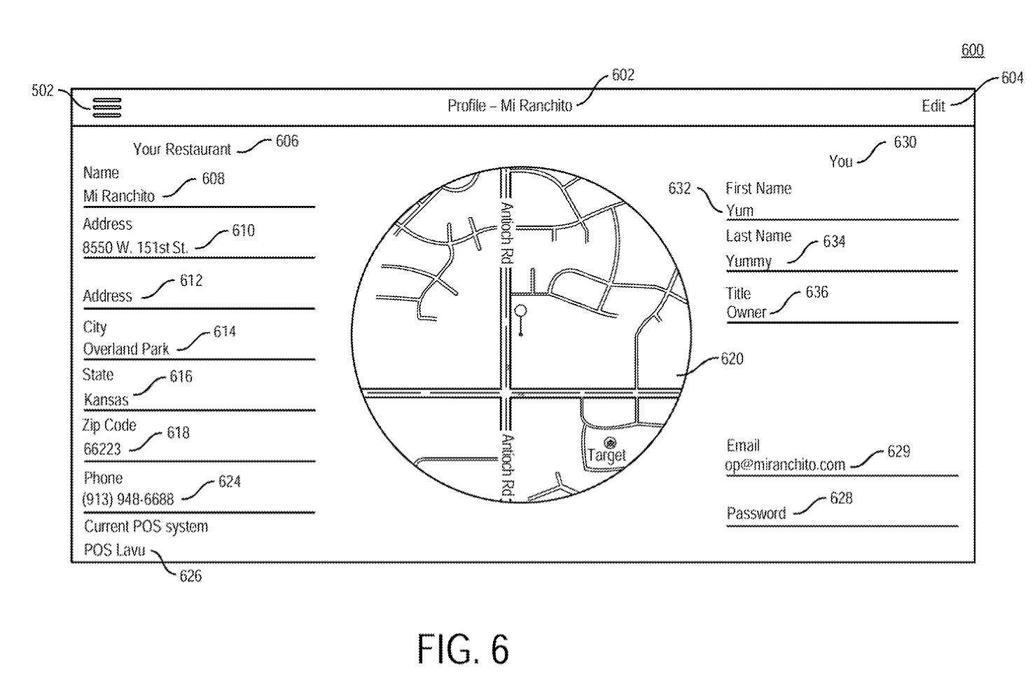

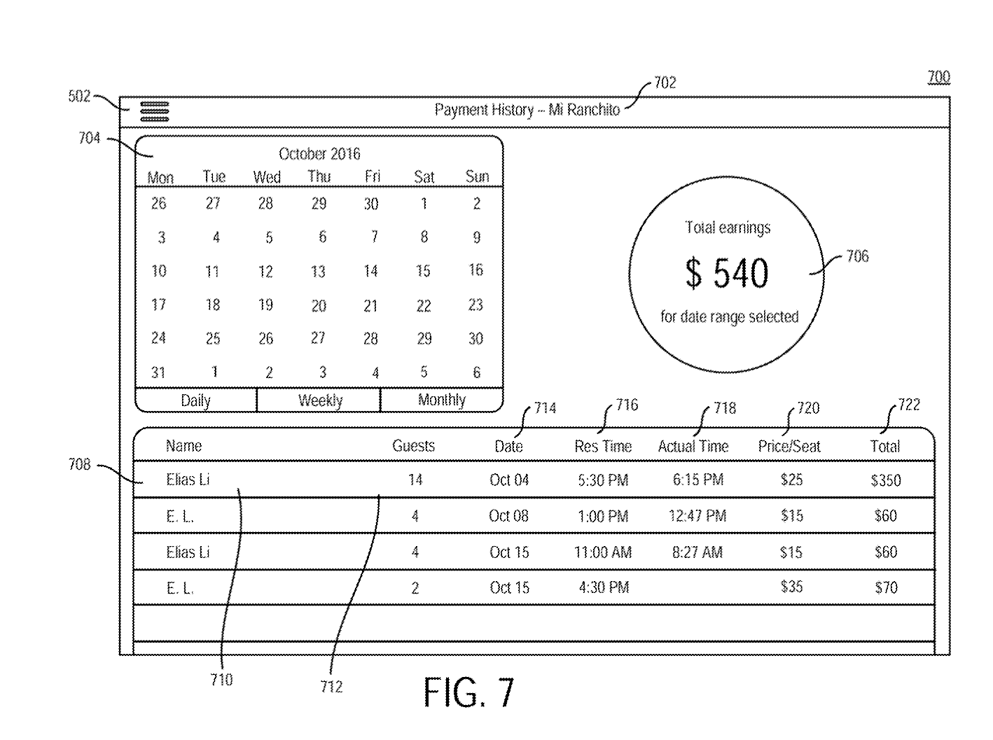

FIG. 5B shows screenshot 520, which appears after the host clicks the drop-down menu icon 502 from screenshot 500 of FIG. 5A. Screenshot 520 shows a list of options to click on such as a dashboard icon 522, a restaurant profile icon 524, a payment history icon 526, a seat schedule icon 528 and a log out icon 529. Clicking on the dashboard icon 522 brings the host back to the dashboard page shown by screenshot 500 of FIG. 5A. Clicking on the restaurant profile icon 524 brings the host to screenshot 600 of FIG. 6, described further below. Clicking on the payment history icon 526 brings the host to screenshot 700 of FIG. 7, also described further below. Clicking on the seat schedule icon 528 brings the host to sereenshots 800, 820, 830 or 840 of FIGS. 8A-8D. Clicking on the log out icon 529 logs the host out of the app and brings them to a login screen (not shown) where they have to enter their credentials to log back info the system and return to the homepage of screenshot 500 shown by FIG. 5A.

FIG. 6 shows a screenshot 600, aftet certain icons are pressed from the homepage, of a host application used by a system to manage reservations, according to an aspect of the present disclosure. Specifically, FIG. 6 shows the screenshot 600 that appears after the restaurant profile icon 524 is pressed from screenshot 520 of FIG. 5B. Screenshot 600 shows the profile of a host (in this case, a restaurant) and drop-down menu icon 502 is discussed above. Screenshot 600 includes a current screen label 602, an edit icon 604, a host title 606, a host name 608, a host first address line 610, a host second address line 612, a host city 614, a host state 616, a host zip code 618, a host phone number 624, a host point of sale (POS) system 626, a host map locator 620, a host contact label 630, a host contact first name 632, a host contact last name 634, a host contact title 636, a host contact email 629 and a host contact password 628. The current screen label 602 displays text to the host describing which page the app is currently at, in this case it is the Profile of a restaurant, entitled “Mi Ranchito”. The edit icon 602, when clicked by the host, allows the host to edit any of the information shown in the fields displayed in screenshot 600, to the extent that they can be edited. The host title 606 denotes a label describing the type of host shown in the profile (e.g., restaurant, service location, vendor), with the fields 608, 610, 612, 614, 616, 618 and 624 being self-explanatory fields where information about the host is entered. The host POS system 626 is a field where the POS system used by the host is specified, in this case, a “POS Lavu” POS system, is being used for transactions. The host map locator 620 is a piece of a map that shows where the host is located, geographically, via a pin at the host's location. The host contact label 630 contains fields 632, 634, 636, 629 and 628 which are self-explanatory fields where information, about a contact individual or person associated with the host is entered.

FIG. 7 shows another screenshot, after certain icons are pressed from the homepage, of a host application used by a system to manage reservations, according to an aspect of the present disclosure. Specifically, FIG. 7 shows screenshot 700, which appears after the payment history icon 526 is pressed from screenshot 520 of FIG. 5B. Screenshot 700 includes drop-down menu icon 502, as described above. Screenshot 700 also includes current screen label 702, a calendar 704, total earnings for selected date range 706, and a reservation entry 708, which in turn includes reserving user ID 710, guest number 712, reservation date 714, reservation time 716, actual time 718, price per seal 720 and total 722. The current screen label 702 displays text describing to the host which page or screen the host is currently at, in this case the Payment History for a restaurant entitled “Mi Ranchito”. The calendar 704 is a calendar displaying a month, day or week at one time, and can be customized to show whatever time frame desired, including a year, in one aspect, although not shown. The total earnings for selected date range 706 shows the total earnings calculated for a provided date range, which may be selected from the calendar 704. In one aspect, the total earnings for the provided date range is the entire time reflected by the calendar 704 and the time span shown or selected by the user. Each reservation entry 708 also shows reserving user ID 710, which is the name, username or other identifying data of the user who made the reservation; guest number 712, which is the number of guests for the reservation; reservation date 714, which is the date of the reservation; reservation time 716, which is the time of the reservation; actual time 718, which is the actual time which the reserving user and their guests checked in, or in one aspect, another time of relevance (e.g., when the guests left, when the guests ordered, when all the guests arrived, and so on), price per seat 720, which is the price charged per seat, and total 722, which is the total amount charged, which may be the guest number 712 multiplied by the price per seat 720, with additional fees (not shown) added, which may be displayed or not displayed on screenshot 700.

FIGS. 8A-8E show other screenshots, after certain icons are pressed from the homepage, of a host application used by a system to manage reservations, according to an aspect of the present disclosure.

FIG. 8A shows screenshot 800 which appears when the host clicks the seat schedule icon 528 in screenshot 520 of FIG. 8B. Screenshot 800 includes drop-down menu icon 502, as described above. Screenshot 800 also includes current screen label 802, save changes icon 804, total seats text 806a and total seats number 806b, seals available for sale text 808a and seats available for sale percentage 808b, average turnaround time text 810a and average turnaround time amount 810b. The current screen label 802 displays text indicating to the host which screen the host is on, in this case, it says “Seat Pricing”. The save changes icon 804, when clicked, saves any changes made to the shown fields when modified, which can be modified in one aspect by clicking on the field or box directly and inputting a number or text. The total seats text 806a reflects a metric that reflects the total seats or spaces available for a reservation, while the total seats number 806b is a number that represents the total seats or spaces available for a reservation. The seats available for sale text 808a is text reflecting the available seats or slots available for sale, whereas the seats available for sale percentage 808b reflects the percentage of total seats that are actually available for sale. The average turnaround time 810a is text indicating the average turnaround time to reserve a seat or slot, or similar text, whereas the average turnaround time amount 810b is the actual average turnaround time it takes, on average, to turn over a table. In one aspect, the average turnaround time amount 810b is how long it takes on average for the user (or diner in the case of a restaurant) is done eating, or done with the scheduled reserved activity at the host. In one aspect, the above-described amounts can be modified when the host clicks on the field or the box containing the field and inputs a number or other text.

Screenshot 800 further shows day toggle switch 812, collapse icon 819, and day entry 814, which includes mealtime entry 818 that in turn includes mealtime name 816a, mealtime time ranges 816b, mealtime price per seat 816c, and ellipsis 816d. For day entry 814, which shows activities such as mealtime entries 818 that occur during a day, the toggle switch 812 can be slid to an on or off position in order to indicate whether or not a given day will be actively taking reservations, e.g. if a host or restaurant is closed for the day reflected by that day entry 814, then the toggle switch 812 can be switched oil, if the host or restaurant is open for the day reflected by that day entry 814, then the toggle switch 812 can be slid on. The collapse icon 819, when clicked, collapses (not shown) or expands (shown fully) the day entry 814. The mealtime entry 818 indicates a given mealtime that occurs during the day reflected by the day entry 814. In one aspect, the mealtime entry 818 can be an event entry of significance that occurs at a host, such as a morning session at a gym or training facility, a morning class at an academy or school, and so on. The mealtime entry 818 includes the mealtime name 816a, which is the name of the mealtime or event; mealtime ranges 816b, which reflect the start and end times of a given mealtime or event; the mealtime price per seat 816c, which reflect the price per seat during that mealtime—which may be modifiable by the host in one aspect by clicking on the box of the mealtime price per seat 816c, and the ellipsis 816d, which when clicked, causes a mealtime bubble 842 to pop up and brings the host to screenshot 850 of FIG. 8E. In one aspect, the mealtime entry 818 can show other fields that are not currently shown in screenshot 800.

FIG. 8B shows screenshot 820 that is similar to screenshot 800 of FIG. 8A in that elements 502, 804, 806a, 806b, 808a, 808b, 810a, 810b, 812, 814, 818, 816a, 816b, 816c, 816d and 819 are described above. However, the current screen label 822 shows to the host that the current screen is “Seat Pricing—Batard” or the seat pricing page for a host or restaurant named “Batard”.

FIG. 8C shows screenshot 830 that is similar to screenshot 820 of FIG. 8B and screenshot 800 of FIG. 8A in that elements 502, 804, 812, 814, 818, 816a, 816b, 816c, 816d, and 819 are described above. However, the current screen label 832 shows to the host that the current screen is “Seat Pricing . . . Clinton Street Baking” or the seat pricing page for a host or restaurant named “Clinton Street Baking”. Furthermore, the elements of 806a, 806b, 808a, 808b, 810a, and 810b present in screenshot 820 of FIG. 8B and screenshot 800 of FIG. 8A are not present in screenshot 830 of FIG. 8C, which is one aspect of the present disclosure.

FIG. 8D shows screenshot 840 that is similar to screenshot 830 of FIG. 8C in that elements 502, 804, 812, 814, 818, 816a, 816b, 816c, 816d, and 819 are described above. However, the current screen label 842 shows to the host that the current screen is “Seat Pricing—Momofuku Nishi” or the seat pricing page for a host or restaurant named “Momofuku. Nishi”. Furthermore, the elements of 806a, 806b, 808a, 808b, 810a, and 810b present in screenshot 820 of FIG. 8B and screenshot 800 of FIG. 8A are not present in screenshot 840 of FIG. 8D, which is one aspect of the present disclosure. In addition, there are more day entries 814 shown in screenshot 830 than the previous screenshot 830 of FIG. 8C.

FIG. 8E shows screenshot 850 that is similar to screenshot 820 of FIG. 8B and screenshot 800 of FIG. 8A in that elements 502, 804, 812, 814, 818, 816a, 816b, 816c, 816d, and 819 are described above. However, the current screen label 852 shows to the host that the current screen is “Seat Pricing—Mi Ranchito” or the seat pricing page for a host or restaurant named “Mi Ranchito”. Screenshot 850 also shows mealtime bubble 842, which includes apply to other days icon 844, rename icon 846 and remove icon 848. The mealtime bubble 842 pops-up when the host clicks on any ellipsis 816d for any of the mealtime entries 818. The mealtime bubble 842 has title text indicating what mealtime entry 818 it was clicked for, in this case it displays “Lunch”. The apply to other days icon 844, when clicked, allows the conditions for the selected mealtime entry 818 corresponding to the clicked ellipsis 816d (such as elements such as mealtime ranges 816b, and mealtime price per seat 816c and/or other un-shown conditions) to apply to other days, as reflected by the different day entries 814. For example, if the apply to other days icon 844 is clicked on this screenshot, then the conditions of the mealtime ranges 816b of 11:00 AM to 1:00 PM and the mealtime price per seat 816c of $15 would be applied to a selected other day entry 14 such as Tuesday, Wednesday or Thursday—where in one aspect, the user can select which day the above conditions apply to from an additional pop-up screen (not shown) or screen (not shown). Clicking on the remove icon 848 removes, empties and refreshes the data entered into elements 816b and 816c, as well as any other conditions that are not shown. To close the mealtime bubble 842 or to make it disappear from the screen, the user can click anywhere outside the mealtime bubble 842. Then, they are brought to a screen that looks very similar to screenshot 800 or 820 of FIGS. 8A or 8B, respectively.

FIGS. 9A-9C show yet other screenshots, after certain icons are pressed from the homepage, of a host application used by a system to manage reservations, according to an aspect of the present disclosure.

FIG. 9A shows screenshot 900, which has a seat price pop-up 901 appear when the host clicks on the seat price icon 506 of screenshot 500 in FIG. 5A. Screenshot 900 includes elements 502, 508, 510, 512, 514, 516a, 516b, 516c and 518 as described above. Current screen label 902 however shows text stating “Dashboard—Clinton Street Baking”, meaning that it is the dashboard, homepage or homescreen for a host having the name “Clinton Street Baking”. Screenshot 960 also includes hide icon 904, mealtime price 906 and available seat percentage 908. The hide icon 904, when clicked by the host, retracts the seat price pop-up 901 and returns the host to screenshot 500 of FIG. 5A. The mealtime price 906 indicates the price per seat for a selected mealtime, in this case, breakfast. In one aspect, the selected mealtime shown for the mealtime price 906 may be chosen by the host and different mealtime prices may also be modified by the host, as described further with reference to screenshot 920 of FIG. 9B. In one aspect, because the system for managing reservations knows the current time, it knows what the price should be for the mealtime for this current time, and the price per seat is also being set in real time as well. The available seat percentage 908 reflects the percentage of total seats or open slots that are still available for sale for a given mealtime or event period.

FIG. 9B shows screenshot 920, which includes elements 901, 902, 904, 906, 908, 502, 508, 510, 512, 514, 516a, 516b, 516c and 518 as described above. When the mealtime price 906 is clicked by the host, a price select bubble 910 appears, listing different seat prices 914 while a current selected seat price 912 is bolded. The host may scroll through the different seat prices 914 shown in the price select bubble 910 to eventually select a current select seat price 912, which becomes the new displayed price in the mealtime price 906. When the mealtime price 906 gets clicked, close button 916 also appears which when clicked, closes the price select bubble 910 and brings the host back to screenshot 900 of FIG. 9A, or another similar looking screenshot. In one aspect, clicking outside the price select bubble 910 closes the price select bubble 910 and brings the host to a screenshot similar to screenshot 930 of FIG. 9C, where the close button 916 is still present on the edge of the mealtime price 906—then, when the close button 916 is clicked, it disappears from the edge of the mealtime price 906 and does not allow the price select bubble 910 to appear, unless the mealtime price 906 is clicked again.

FIG. 9C shows screenshot 930, which includes 901, 902, 904, 906, 908, 916, 502, 508, 510, 512, 514, 516a, 516b, 516c and 518 as described above. When the available seat percentage 908 is clicked by the host, a percentage select bubble 926 appears, listing different available seat percentages 924 while a current select available seat percentage 922 is bolded. The host may scroll through the different available seat percentages 924 shown in the percentage select bubble 926 to eventually select a current select available seat percentage 922, which becomes the new displayed available seat percentage in the available seat percentage 908. When the available seat percentage 908 gets clicked, close button 928 also appears which when clicked, closes the percentage select bubble 926 and brings the host back to screenshot 900 of FIG. 9A, or another similar looking screenshot. In one aspect, clicking outside the percentage select bubble 926 closes the percentage select bubble 926 and brings the host to a screenshot similar to screenshot 930 of FIG. 9C, where the close button 928 is still present on the edge of the available seat percentage 908—then, when the close button 928 is clicked, it disappears from the edge of the available seat percentage 908 and does not allow the percentage select bubble 926 to appear, unless the available seat percentage 908 is clicked again.

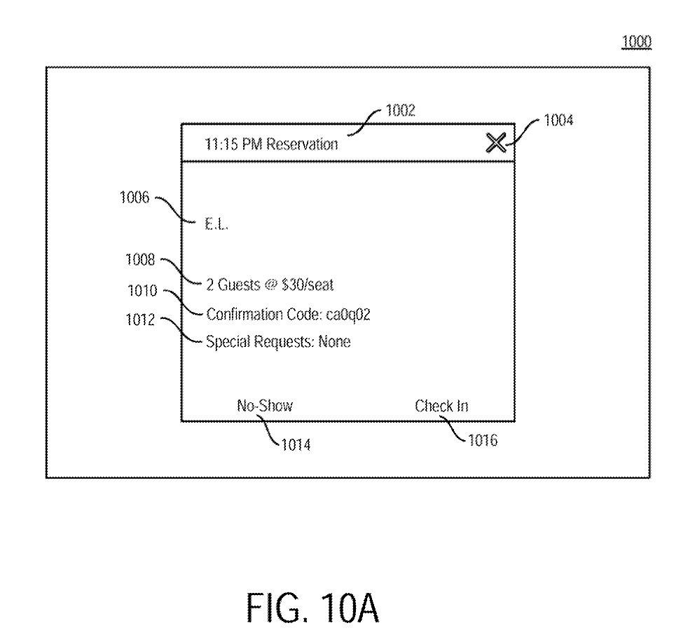

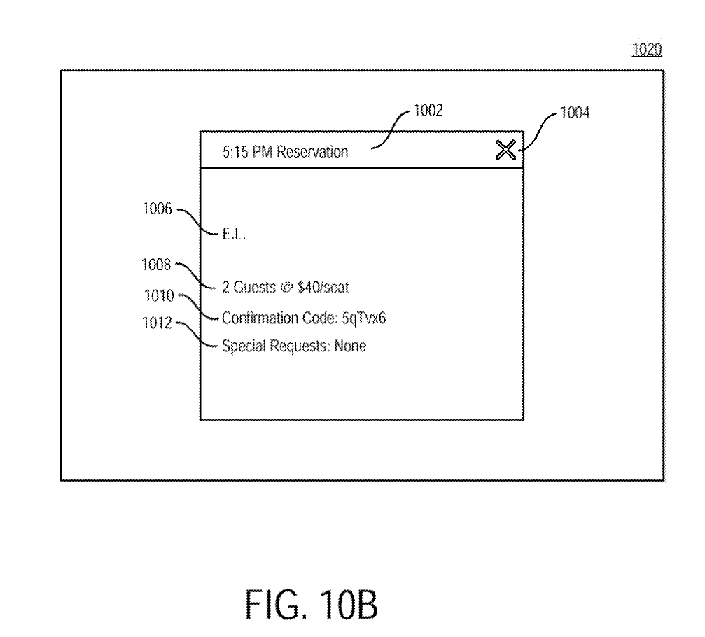

FIGS. 10A-10B shows screenshots 1000 and 1020, alter certain icons are pressed from the screenshots shown in FIGS. 9A-9C of a host application used by a system to manage reservations, according to an aspect of the present disclosure.

Specifically, screenshot 1000 of FIG. 10A results when the host clicks on element 516a, 516b, 516c, or 516d of FIGS. 5A, 9A-9C. In one aspect, the host may also be taken to screenshot 1000 if he or she clicks element 516e in FIGS. 5A, 9A-9C. Screenshot 1000 includes reservation confirmation window 1002, close button 1004, reserving user ID 1006, guest number and rate 1008, confirmation code 1010, special requests 1012, no-show icon 1014 and check in icon 1016. The reservation confirmation window 1002 lists the time of the reservation, and clicking on the close button 1004 closes the reservation confirmation window 1002. The reserving user ID 1006 is the name, username or other identifying data that identifies the riser who made the reservation. The guest number and rate 1008 shows the number of guests and the price per seat for the reservation. The confirmation code 1010 is a code that the user or any of their guests can input in order to retrieve a page that lists a confirmation of their reservation. The special requests 1012 lists any special requests that the user or their guests request for the reservation, such as the location of particular seats, or a particular type of service, or anything that can be requested. When the no-show icon 1014 is clicked by the host, then a message or indication is sent to the system managing reservations that the user and their guests are a no-show. The host is then brought to screenshot 1020 of FIG. 10B, where there is no display of the no-show icon 1014 or the check in icon 1016. Similarly, when the check in icon 1016 is clicked by the host, then a message or indication is sent to the system managing reservations that the user and their guests have checked in. The host is then brought to screenshot 1020 of FIG. 10B, where there is no display of the no-show icon 1014 or the check in icon 1016.

FIG. 10B shows screenshot 1020 that appears alter the host clicks the no-show icon 1014 or the check-in icon 1016 of screenshot 1000 of FIG. 10A, as described above. Screenshot 1020 also includes elements 1002, 1004, 1006, 1008, 1010 and 1012, as described above. Screenshot 1020 does not display the no-show icon 1014 or the check in icon 1016 of screenshot 1000 of FIG. 10A because a choice has already been made by the host and one of those icons has been clicked or pushed, as described above. Therefore, the icons 1014 and 1016 no longer show up or are visible.

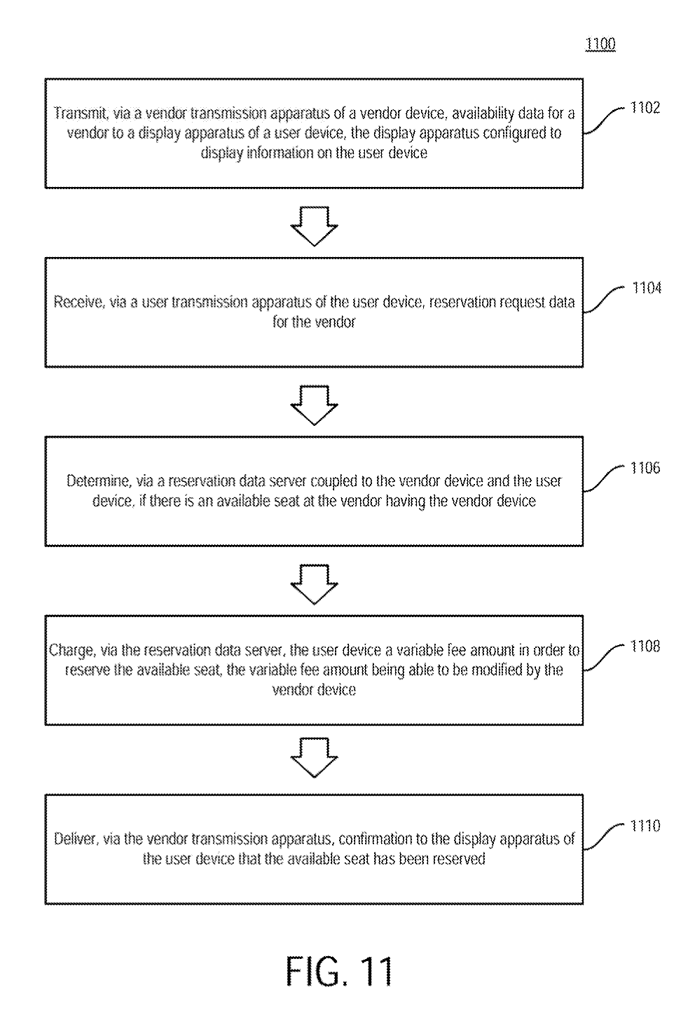

FIG. 11 shows a process flowchart of a method 1100 to manage reservations, according to an aspect of the present disclosure. Method 1100 contains box 1102, where the act of transmitting, via a vendor transmission apparatus of a vendor device, availability data for a vendor to a display apparatus of a user device is performed, the display apparatus configured to display information on the user device. In box 1104, the act of receiving, via a user transmission apparatus of the user device, reservation request data for the vendor, is performed. In box 1106, the act of determining, via a reservation data server coupled to the vendor device and the user device, is performed, if there is an available seat at the vendor having the vendor device. In box 1108, the act of charging, via the reservation data server, the user device a variable fee amount in order to reserve the available seat is performed, the variable fee amount being able to be modified by the vendor device. In box 1110, the act of delivering, via the vendor transmission apparatus, confirmation to the display apparatus of the user device that the available seat has been reserved is performed.

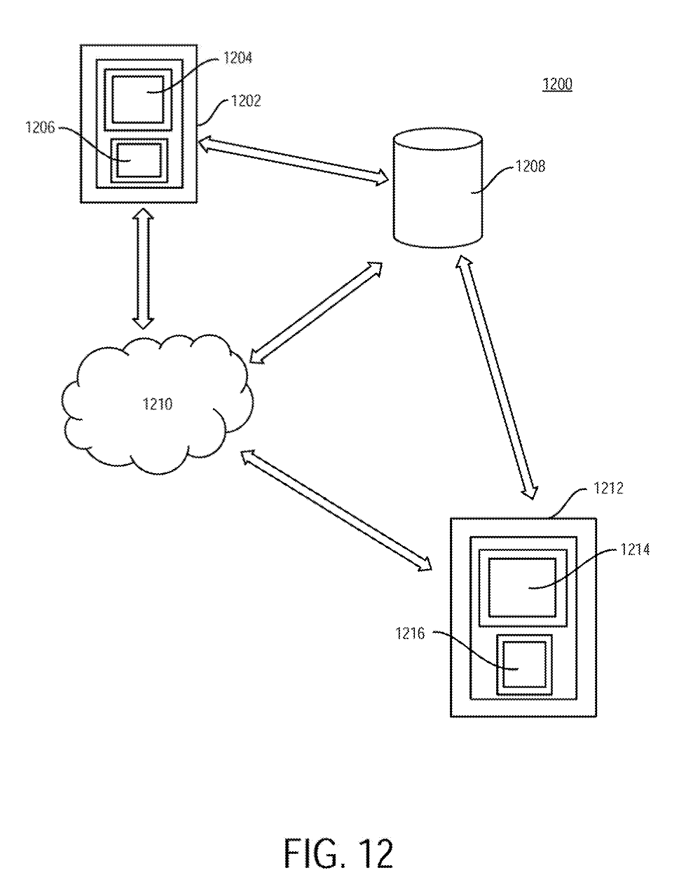

FIG. 12 shows a diagram 1200 of a system for managing reservations, according to an aspect of the present disclosure. Diagram 1200 includes vendor device 1202, which in turn includes a vendor display apparatus 1204 and a vendor transmission apparatus 1206; and a user device 1212, which in turn includes a user display apparatus 1214 and a user transmission apparatus 1216. The vendor device 1202, the reservation data server 1208 and the user device 1212 are all coupled to the internet 1210. A vendor can use the vendor device 1202, and a user can use the user device 1212. The vendor transmission apparatus 1206 is configured to transmit availability data for a vendor, who again may be using the vendor device 1202, and also an availability confirmation. The user display apparatus 1214 is configured to display on the user device 1212 information including the availability confirmation. The user transmission apparatus 1216 is configured to receive reservation request data for the vendor, who may again be using the vendor device 1202. The reservation data server 1208 is coupled to both the vendor device 1202 and the user device 1212. The reservation data 1208 is also configured to determine if there is an available seat at the vendor using the vendor device 1202, wherein the reservation data server 1208 is also configured to charge the user device 1212 a variable fee amount in order to reserve the available seat, the variable fee amount being modifiable by the vendor device 1202.

One major advantage is that the variable fee or fee that a user has to pay in order to reserve a seat or ticket at a vendor or host is dynamically calibrated based on a number of different factors including current time demand, historical time transaction data and local geographical data. The current time demand reflects the demand of reservations at the vendor or host at the current time. The historical time transaction data describes the history of transactions users may have with the vendor or host. The local geographical data describes the geographic location where the vendor is located. These factors work together to adjust and calibrate a dynamic, variable fee price for the reservations that benefits users and vendors alike.

In one aspect, the reservation made at a vendor or host is not a mere reservation and is a pre-payment, meaning that the reservation is paid for even before the user comes in and sits down at the restaurant. Therefore, this is a distinction between other prior art restaurant reservation apps out there in that those apps deal with reservations, many of which have often not been paid, while the current application of the present system deals with pre-payments of reservations, which have already been paid by a user. In other words, the restaurant or vendor already receives the payment from the user versus a reservation or request to hold a seat, which can be cancelled by the user at any time. This way, the vendor can collect payment immediately instead of having users cancel their reservations frequently, which leads to more predictability and higher income that comes at more of a regular basis—which may also be analyzed or plotted easier in terms of statistics or profit reports of a vendor.

Also, in one aspect, promotions, events (such as “meet the chef”), incentives, deals, discounts to be modified based on current demand, and in real time. For example, say a restaurant declares a special deal that if a user books two or more seats at $25 a seat, the user can get a free dessert. Only available Monday through Thursday. This allows vendors such as restaurants and businesses to offer special time sensitive offers, in real time and as needed. If the vendors want to pull or remove the offers, they can do that when they want, and it's only good for the days the vendor says it is good for.

In one aspect, because a QR Code and unique ID is generated alter each seat or reservation is purchased, such an identification code can be used as a ticketing mechanism. These identification codes include a QR code, barcode, a passcode, a confirmation number, a confirmation word, a confirmation image and any other image or code identifying that the user purchased a ticket. For example, a vendor can place an event on the app. If a user clicks on that event, a seat can be purchased for that date and time. The user can then be given a QR code and unique ID that can then be used for entry into the event. Furthermore, prices for that event will change based on the time the user wants to come in. As a further example, if a user wants to come to a EXPO at 10 am—it's $15, but if you come in at 3 pm it's only $10 because there is only 2 hours left for the event.

According to an aspect of the disclosure, provided is a computer-implemented method for use with a system for managing reservations, including: transmitting, via a vendor transmission apparatus of a vendor device, availability data for a vendor to a display apparatus of a user device, the display apparatus configured to display information on the user device; receiving, via a user transmission, apparatus of the user device, reservation request data for the vendor; determining, via a reservation data server coupled to the vendor device and the user device, if there is an available seat at the vendor having the vendor device; charging, via the reservation data server, the user device a variable fee amount in order to reserve the available seat, the variable fee amount being able to be modified by the vendor device; and delivering, via the vendor transmission apparatus, confirmation to the display apparatus of the user device that the available seat has been reserved.

In one aspect, the vendor using the vendor device includes a quick service restaurant (QSR), a full service restaurant (FSR), and a fast casual restaurant (FCR).

In one aspect, the system for managing reservations receives a first percentage of the variable fee amount if the vendor is a FSR and receives a second percentage of the variable fee amount if the vendor is a QSR or FCR, after subtracting a credit card processing fee that is also a percentage of the variable fee amount, wherein the first percentage ranges from 8-12%, the second percentage ranges from 3-10% and the credit card processing fee ranges from 1-3% of the variable fee amount.

In one aspect, the availability data for a vendor is shown on the display apparatus of the user device in real-time as openings on a geographical map that changes based on the location of the user device, according to global positioning satellite (GPS) tracking.

In one aspect, the vendor comprises a FSR and further wherein showing the availability data for the vendor on the display apparatus of the user device in real-time includes: receiving, via the vendor transmission apparatus of the vendor device, a number of available seats, an average length for meal completion, and a percentage of purchasable available seats, wherein the number of available seats may be provided in real-time and changed by the vendor device; calculating, via the reservation data server coupled to the vendor device and the user device, an available seats per time unit metric based on the number of available seats, the average length for meal completion and the percentage of purchasable available seats; exhibiting, via the display apparatus of the user device, the availability data for the vendor based on the available seats per time unit metric.

In one aspect the variable fee amount is based on at least current time demand, historical time transaction data and local geographical data, the current time demand reflecting the demand of reservations at the vendor at the current time, the historical time transaction data describing the history of transactions users may have with the vendor and the local geographical data describing the geographic location where the vendor is located, and further wherein the variable fee amount can be modified by the vendor device as well as charged to the user device in real time.

In one aspect, the above method also includes: transmitting, via the vendor transmission apparatus of the vendor device, event data for an event associated with the vendor to the display apparatus of the user device; receiving, via the user transmission apparatus of the user device, RSVP data for the event; determining, via a reservation data server coupled to the vendor device and the user device, if there is an available seat for the event; delivering, via the vendor transmission apparatus, confirmation to the display apparatus of the user device that the available seat at the event has been reserved.

In one aspect, the above method also includes charging, via the reservation data server, the user device a variable event fee amount in order to reserve the available seat for the event, the variable event fee amount being able to be modified or removed by the vendor device in real time and wherein the variable event fee amount is based on at least current time demand, historical time transaction data and local geographical data, the current time demand reflecting the demand of reservations at the vendor at the current time, the historical time transaction data describing the history of transactions users may have with the vendor and the local geographical data describing the geographic location, where the vendor is located.

In one aspect, the event includes any promotion, any discount, any purchasing deal, any purchasing incentive, a meet the chef event, a meet the chef event, a meet the founder event, a fundraising event, a birthday party, a wedding, a bachelor's party, a religions party event, a business presentation, a business meeting, an internal company event and a networking event.

In one aspect, the above method includes storing, via the reservation data server, any payment information used to charge the variable fee amount to the user device for the available seat at the vendor; and recalling, via the vendor transmission apparatus of the vendor device, the payment information so that the user device does not have to re-enter the payment information from again.

In one aspect, the user device is queried before the payment information used to charge the variable fee amount to the user device is stored via the reservation data server and if the user device does not agree for the payment information to be stored, it is not stored via the reservation data server.

In one aspect, the confirmation to the display apparatus of the user device that the available seat has been reserved can be used as a ticket to an event or for ticketing purposes and further wherein the confirmation includes a QR code, a barcode, a passcode, a confirmation number, a confirmation word, a confirmation image and any other image or code identifying that the user purchased a ticket.

In one aspect, the system for managing reservations performs automatic pricing of seats during the week. In one aspect of the present disclosure, a machine learning program will optimize the prices for each seat throughout each day and each hour.

In one aspect, the system for managing reservations automatically adjusts prices for QSR and Fast Casual. In one aspect, the prices of food will be automatically adjusted based on demand and history.

In one aspect, the system for managing reservations will provide predictive suggestions of where to eat (to a user via the user device, for example) based on personal past usage of the app (e.g. by a user via the user device).

In one aspect, the system for managing reservations is directed to (1) the dynamic pricing and calibration of reservation seats based on both (a) time-based/history factors, or historical time transaction data, such as the time that the reservation seat is made and the history of user activity and (b) local geographical factors, or local geographical data, such as where the reservation seats are and where the user may be based.

In one aspect, the system for managing reservations is also directed to: (2) a pre-payment aspect, in that the holding of spots at a vendor is not a mere reservation and those spots at the vendor are actually being pre-paid.

In one aspect, a computer-implemented system for managing reservations, includes: at least one computing device configured to submit reservation request data and confirmed availability request data to a reservation data server and to receive vendor availability data and confirmed reservation data from the reservation data server, the at least one computing device comprising a graphic user interface (GUI) and a plurality of user input keys and the reservation request data, the vendor availability data, the confirmed availability request data and the confirmed reservation data are associated with at least one vendor; a reservation data sewer to receive, store and process reservation request data, receive availability data from the at least one vendor and confirmed availability data and output confirmed reservation data, the reservation data server including: a vendor availability processor configured to receive and transform the reservation request data and the availability data from the at least one vendor into vendor availability data and transmit the vendor availability data to the at least one computing device; and a reservation processor configured to receive and transform the confirmed availability request data into confirmed reservation data; and the at least one vendor, each configured to transmit availability data to the reservation data server for a nominal fee.

In one aspect, the nominal fee is zero dollars, or free.

In one aspect, the GUI and the plurality of user input keys are used to search for and select a chosen vendor from the at least one vendor on a geographical map display that tracks the location of the computing device and nearby vendors to the computing device via a global positioning satellite (GPS), thereby sending reservation request data associated with the chosen vendor to the reservation data server.

In one aspect, the geographical map display shows available vendors based on the availability data from the at least one vendor.

In one aspect, the GUI and the plurality of user input keys are used to search for and select the chosen vendor via inputting the chosen vendor's name in a field box.

In one aspect, the computing device displays, via the GUI, at least one availability opening from the chosen vendor based on vendor availability data sent to the computing device from the reservation data server.

In one aspect, the plurality of user keys can be used to select a chosen availability opening from the at least one availability opening, which sends confirmed availability data back to the reservation data server.

In one aspect, the computing device displays, via the GUI, at least one confirmed reservation based on the confirmed reservation data sent by the reservation data server after receiving the confirmed availability data.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

For a firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not to be limited, to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the technology of the disclosure as defined by the appended claims. For example, relational terms, such, as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

What is claimed is:

1. A computer-implemented method for use with a system for managing reservations, comprising:
transmitting, via a vendor transmission apparatus of a vendor device, availability data for a vendor to a display apparatus of a user device, the display apparatus configured to display information on the user device;
receiving, via a user transmission apparatus of the user device, reservation request data for the vendor;
determining, via a reservation data server coupled to the vendor device and the user device, if there is an available seat at the vendor having the vendor device;
charging, via the reservation data server, the user device a variable fee amount in order to reserve the available seat, the variable fee amount being able to be modified by the vendor device; and
delivering, via the vendor transmission apparatus, confirmation to the display apparatus of the user device that the available seat has been reserved.

2. The computer-implemented method of claim 1, wherein the vendor using the vendor device comprises a quick service restaurant (QSR), a full service restaurant (FSR), and a fast casual restaurant (FCR).

3. The computer-implemented method of claim 2, wherein the system for managing reservations receives a first percentage of the variable fee amount if the vendor is a FSR and receives a second percentage of the variable fee amount if the vendor is a QSR or FCR, after subtracting a credit card processing fee that is also a percentage of the variable fee amount, wherein the first percentage ranges from 8-12%, the second percentage ranges from 3-10% and the credit card processing fee ranges from 1-3% of the variable fee amount.

4. The computer-implemented method of claim 2, wherein the availability data for a vendor is shown on the display apparatus of the user device in real-time as openings on a geographical map that changes based on the location of the riser device, according to global positioning satellite (GPS) tracking.

5. The computer-implemented method of claim 4, wherein the vendor comprises a FSR and further wherein showing the availability data for the vendor on the display apparatus of the user device in real-time comprises:
receiving, via the vendor transmission apparatus of the vendor device, a number of available seats, an average length for meal completion, and a percentage of purchasable available seats, wherein the number of available seats may be provided in real-time and changed by the vendor device;
calculating, via the reservation data server coupled to the vendor device and the user device, an available seats per tune unit metric based on the number of available seats, the average length for meal completion and the percentage of purchasable available seats;
exhibiting, via the display apparatus of the user device, the availability data for the vendor based on the available seats per time unit metric.

6. The computer-implemented method of claim 1, wherein the variable fee amount is based on at least current time demand, historical time transaction data and local geographical data, the current time demand reflecting the demand of reservations at the vendor at the current time, the historical time transaction data describing the history of transactions users may have with the vendor and the local geographical data describing the geographic location where the vendor is located,
and further wherein the variable fee amount can be modified by the vendor device as well as charged to the user device in real time.

7. The computer-implemented method of claim 1, further comprising:
transmitting, via the vendor transmission apparatus of the vendor device, event data for an event associated with the vendor to the display apparatus of the user device;
receiving, via the user transmission apparatus of the user device, RSVP data for the event;
determining, via a reservation data server coupled to the vendor device and the user device, if there is an available seat for the event;
delivering, via the vendor transmission apparatus, confirmation to the display apparatus of the user device that the available seat at the event has been reserved.

8. The computer-implemented method of claim 7, further comprising:
charging, via the reservation data server, the user device a variable event fee amount in order to reserve the available seat for the event, the variable event fee amount being able to be modified or removed by the vendor device in real time and wherein the variable event fee amount is based on at least current time demand, historical time transaction data and local geographical data, the current time demand reflecting the demand of reservations at the vendor at the current time, the historical time transaction data describing the history of transactions users may have with the vendor and the local geographical data, describing the geographic location where the vendor is located.

9. The computer-implemented method of claim 8, wherein the event comprises any promotion, any discount, any purchasing deal, any purchasing incentive, a meet the chef event, a meet the founder event, a fundraising event, a birthday party, a wedding, a bachelor's party, a religious party event, a business presentation, a business meeting, an internal company event and a networking event.

10. The computer-implemented method of claim 1, further comprising:
storing, via the reservation data server, any payment information used to charge the variable fee amount to the user device for the available seat at the vendor; and
recalling, via the vendor transmission apparatus of the vendor device, the payment information so that the user device does not have to re-enter the payment information from again.

11. The computer-implemented method of claim 10, wherein the user device is queried before the payment information used to charge the variable fee amount to the user device is stored via the reservation data server and if the user device does not agree for the payment information to be stored, it is not stored via the reservation data server.

12. The computer-implemented method of claim 1, wherein the confirmation to the display apparatus of the user device that the available seat has been reserved can be used as a ticket to an event or for ticketing purposes and further wherein the confirmation includes a QR code, a barcode, a passcode, a confirmation number, a confirmation word, a confirmation image and any other image or code identifying that the user purchased a ticket.

13. A computer-implemented system for managing reservations, comprising:
at least one computing device configured to submit reservation request data and confirmed availability request data to a reservation data server and to receive vendor availability data and confirmed reservation data from the reservation data server, the at least one computing device comprising a graphic user interface (GUI) and a plurality of user input keys and the reservation request data, the vendor availability data, the confirmed availability request data and the confirmed reservation data are associated with at least one vendor;
a reservation data server to receive, store and process reservation request data, receive availability data from the at least one vendor and confirmed availability data and output confirmed reservation data, the reservation, data server comprising:
a vendor availability processor configured to receive and transform the reservation request data and the availability data from the at least one vendor into vendor availability data and transmit the vendor availability data to the at least one computing device; and
a reservation processor configured to receive and transform the confirmed availability request data into confirmed reservation data; and
the at least one vendor, each configured to transmit availability data to the reservation data server for a nominal fee which includes a charge of zero dollars or free.

14. The computer-implemented system of claim 13, wherein the GUI and the plurality of user input keys are used to search for and select a chosen vendor from the at least one vendor on a geographical map display that tracks the location of the computing device and nearby vendors to the computing device via a global positioning satellite (GPS), thereby sending reservation request data associated with the chosen vendor to the reservation data server.

15. The computer-implemented system of claim 14, wherein the geographical map display shows available vendors based on the availability data from the at least one vendor.

16. The computer-implemented system of claim 14, wherein the GUI and the plurality of user input keys are used to search for and select the chosen vendor via inputting the chosen vendor's name in a field box.

17. The computer-implemented system of claim 14, wherein the computing device displays, via the GUI, at least one availability opening from the chosen vendor based on vendor availability data sent to the computing device from the reservation data server.

18. The computer-implemented system of claim 17, wherein the plurality of user keys can be used to select a chosen availability opening from the at least one availability opening, which sends confirmed availability data back to the reservation data server.

19. The computer-implemented system of claim 18, wherein the computing device displays, via the GUI, at least one confirmed reservation based on the confirmed reservation data sent by the reservation data server after receiving the confirmed availability data.

20. A computer-implemented system for managing reservations, comprising:
a vendor device comprising:
a vendor display apparatus configured to display on the vendor device information; and
a vendor transmission apparatus configured to transmit availability data for a vendor and also an availability confirmation;
a user device comprising:
a user display apparatus configured to display on the user device information including the availability confirmation; and
a user transmission apparatus configured to receive reservation request data for the vendor; and
a reservation data server coupled to the vendor device and the user device configured to determine if there is an available seat at the vendor using, the vendor device, wherein the reservation data server is also configured to charge the user device a variable fee amount in order to reserve the available seat, the variable the amount being modifiable by the vendor device.
